(19) United States
(12) Patent Application Publication
(10) Pub. No.: US 2025/0056409 A1
(43) Pub. Date: Feb. 13, 2025

(54) WIRELESS COMMUNICATION WITH POWER STATE TRANSITIONS

(71) Applicant: QUALCOMM Incorporated, San Diego, CA (US)

(72) Inventors: Diana MAAMARI, San Diego, CA (US); Mickael MONDET, Louannec (FR); Prashanth Haridas HANDE, San Diego, CA (US); Kianoush HOSSEINI, San Diego, CA (US)

(21) Appl. No.: 18/447,060

(22) Filed: Aug. 9, 2023

(51) Int. Cl. H04W 52/02; H04W 28/02; H04W 72/20; H04W 76/28

(52) U.S. Cl. CPC H04W 52/0235; H04W 28/0278; H04W 52/0251; H04W 72/20; H04W 76/28

(57) ABSTRACT

Apparatuses and methods for on power state transitions are described. An apparatus is configured to receive, from a network node, a DL EOC indication to trigger a status indication. The apparatus is configured to transmit, to the network node and based on the DL EOC indication, the status indication indicative of a status of a buffer or a delay of the UE and an estimated time at which the UE estimates an arrival of a next UL packet. Another apparatus is configured to transmit, to a UE, a DL EOC indication to trigger a status indication. The apparatus is configured to receive, from the UE and based on the DL EOC indication, the status indication indicative of a status of a buffer or a delay of the UE and an estimated time at which the UE estimates an arrival of a next UL packet.

### TECHNICAL FIELD

The present disclosure relates generally to communication systems, and more particularly, to wireless communications utilizing different power states.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be associated with, or may be, a user equipment (UE). The apparatus is configured to receive, from a network node, a downlink (DL) end of communication (EOC) indication to trigger a status indication. The apparatus is also configured to transmit, to the network node and based on the DL EOC indication, the status indication indicative of a status of (i) a buffer of the UE or a delay of the UE, and (ii) an estimated time that indicates a time at which the UE estimates an arrival of a next UL packet.

In the aspect, the method includes receiving, from a network node, a DL EOC indication to trigger a status indication. The method also includes transmitting, to the network node and based on the DL EOC indication, the status indication indicative of a status of (i) a buffer of the UE or a delay of the UE, and (ii) an estimated time that indicates a time at which the UE estimates an arrival of a next UL packet.

In another aspect of the disclosure, a method, a computer-readable medium, and an apparatus are provided. The apparatus is configured to transmit, to a UE, a DL EOC indication to trigger a status indication. The apparatus is also configured to receive, from the UE and based on the DL EOC indication, the status indication indicative of a status of (i) a buffer of the UE or a delay of the UE, and (ii) an estimated time that indicates a time at which the UE estimates an arrival of a next UL packet.

In the aspect, the method includes transmitting, to a UE, a DL EOC indication to trigger a status indication. The method also includes receiving, from the UE and based on the DL EOC indication, the status indication indicative of a status of (i) a buffer of the UE or a delay of the UE, and (ii) an estimated time that indicates a time at which the UE estimates an arrival of a next UL packet.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of scheduling request (SR) overrides with physical downlink control channel (PDCCH) skipping and search space set (SSS) group (SSSG) switching, in accordance with various aspects of the present disclosure.

FIG. 5 is a diagram illustrating example XR traffic, in accordance with various aspects of the present disclosure.

FIG. 6 is a call flow diagram for wireless communications, in accordance with various aspects of the present disclosure.

FIG. 7 is a diagram illustrating example power states and associated codepoints, as well as a call flow diagram for wireless communications, in accordance with various aspects of the present disclosure.

FIG. 8 is a diagram illustrating example uplink control information (UCI) codepoints and conditional downlink control information (DCI) for power states, in accordance with various aspects of the present disclosure.

FIG. 9 is a diagram illustrating examples for UL and DL transmissions associated with power states and estimated times, in accordance with various aspects of the present disclosure.

FIG. 10 is a diagram illustrating example UL grant handling after status indications and wake up signal monitoring for autonomous power state transitions, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks may enable traffic flows with specific characteristics and that utilize communications and sensing for applications. Traffic flows may have various characteristics in wireless communication networks, e.g., including layer attributes, timeframes for latency, power saving configurations, etc. As an example, extended reality (XR) traffic for UL and DL may have characteristics such as application layer attributes, short timeframes for exchange where longer latency for traffic flows may reduce a user experience with an XR application or device, unbalanced traffic flows, etc. In scenarios where there may be unbalanced traffic, for example, the traffic may be dominated by UL packets for a certain amount of time, while in other scenarios, there may be DL packets present for certain amount of time. Power saving configurations for XR may include UL states (e.g., without DL communications) triggered by inactivity or express triggers (e.g., via DCI). Other configurations, such as for PDCCH skipping, may save power by allowing a UE skip monitoring for DL PDCCH data/information.

Aspects presented herein provide mechanisms for transitioning between power states. For instance, in the context of XR, aspects presented herein enable added granularity and faster transitions than discontinuous reception (DRX) or connected mode DRX (C-DRX) active-inactive states, and C-DRX transitions designed for eMBB/voice traffic based on inactivity timers. Aspects presented herein enable SSSG state/PDCCH skipping that take quasi-periodic structures into account and additional granularity of power states (e.g. UL power states without DL monitoring). Further regarding PDCCH skipping, latency may be introduced for UL scheduling as communication (in both UL and DL) may not occur when a UE does not monitor PDCCH. To reduce the UL scheduling latency, a UE may indicate the stop of PDCCH skipping or to override the SSSG switching via the transmission of a scheduling request (SR) if the UE has urgent UL data to transmit (e.g., the UE may switch back to regular PDCCH monitoring to monitor uplink grants after sending the SR. Related to reducing latency, a UE may terminate PDCCH skipping if there is a pending negative acknowledgement (NACK). Yet, such configurations do not account for scenarios without urgent UL data. For instance, if a UE cancels PDCCH skipping, a base station (e.g., a gNB and/or the like) may have already sent a superfluous PDCCH skipping indication for the UE to go sleep (whether this is scheduling DCI or non-scheduling DCI-a non-scheduling DCI may be in the form of dummy grant with zero resource block allocation and used for indicating PDCCH skipping (e.g., used for nothing else)). Further, a base station (e.g., a gNB and/or the like) may not have awareness/information that a UE is going to send a positive SR so close to a PDCCH skipping indication, which may also warrant the base station to send a superfluous indication. Similarly, sending DCI may use PDCCH resources and may be considered an overhead in terms of power and resources. Accordingly, aspects presented herein provide improvements that enable the base station to make better decisions on whether to send skipping indications or not. Aspects herein provide solutions that cover transitions in an out of power states.

Various aspects relate generally to wireless communications systems utilizing different power states. some aspects more specifically relate to “on” power state transitions. In one example, a UE may receive, from a network node, a DL EOC indication to trigger a status indication. The UE may also transmit, to the network node and based on the DL EOC indication, the status indication indicative of a status of (i) a buffer of the UE or a delay of the UE, and (ii) an estimated time that indicates a time at which the UE estimates an arrival of a next UL packet. The UE may receive, from the network node, a power state switching indication that indicates a mode of operation for the UE based on at least one of the status of the buffer of the UE, the delay of the UE, or the estimated time. The UE may switch to the mode of operation for the UE based on the power state switching indication. The UE may transmit, to the network node, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode based on a second time period. The UE may, during a time period after transmitting the status indication and prior to the estimated time, receive, from the network node, an UL grant for UL traffic associated with data in the buffer of the UE. The UE may, during the time period after transmitting the status indication and prior to the estimated time transmit, for the network node, the UL traffic based on the UL grant. The UE may transmit, for the network node, a capability indication of the UE that indicates at least one of a first capability of the UE to estimate a traffic condition or a second capability of the UE to provide the estimated time. The UE may switch, autonomously by the UE, to a mode of operation for the UE subsequent to transmitting the status indication, where the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a PDCCH. The UE may monitor, while in the mode of operation, for a wake up signal (WUS), from the network node, that includes a sequence type. The UE may receive, from the network node, the WUS that includes the sequence type. The UE may switch to another of the first mode, the second mode, the third mode, or the fourth mode for the UE based on the sequence type. In another example, a network node (or base station and/or the like) may transmit, to a UE, a DL EOC indication to trigger a status indication. The network node may also receive, from the UE and based on the DL EOC indication, the status indication indicative of a status of (i) a buffer of the UE or a delay of the UE, and (ii) an estimated time that indicates a time at which the UE estimates an arrival of a next UL packet. The network node may transmit, to the UE, a power state switching indication that indicates a mode of operation for the UE based on at least one of the status of the buffer of the UE, the delay of the UE, or the estimated time. The network node may receive, from the UE, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode wake up based on a second period of time. The network node may, during a time period after transmitting the status indication and prior to the estimated time, transmit, for the UE, an UL grant for UL traffic associated with data in the buffer of the UE. The network node may, during the time period after transmitting the status indication and prior to the estimated time, receive, from the UE, the UL traffic based on the UL grant. The network node may receive, from the UE, a capability indication of the UE that indicates at least one of a first capability of the UE to estimate a traffic condition or a second capability of the UE to provide the estimated time. The network node may receive, from the UE, an operation indication that indicates an autonomous switch in operation of the UE for the third mode or the second mode, where the operation indication is comprised in at least one of UCI, a medium access control (MAC) control element (MAC-CE), or UE assistance information (UAI). The network node may transmit, to the UE, a WUS that includes a sequence type, where the sequence type is associated with a switch of the UE to another of the first mode, the second mode, the third mode, or the fourth mode for the UE.

Particular aspects of the subject matter described in this disclosure can be implemented to realize one or more of the following potential advantages. In one example, by enhancing status reports to include estimated times for UL data and/or delay reports, the described techniques can be used to improve efficiency of communications and reduce consumption power of devices associated with a wireless network. In another example, by utilizing new MAC-CEs, introduced to include the estimated time of arrival or a preferred grant configuration (e.g., for time, frequency (such as a number of RBs, a number of OFDM symbols, repetition, and/or the like), instead of enhancing status reports, the described techniques can be used to improve efficiency of communications and reduce consumption power of devices associated with a wireless network. In an additional example, by utilizing DL EOC indications to trigger status reports, the described techniques can be used to further improve efficiency of communications and reduce power consumption of wireless devices, as well as quickly provide UE information to a base station without additional signaling. In another example, by monitoring of various wake up signals, the described techniques can be used to allow a UE to autonomously transition to a different power state after providing a status indication to a base station.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

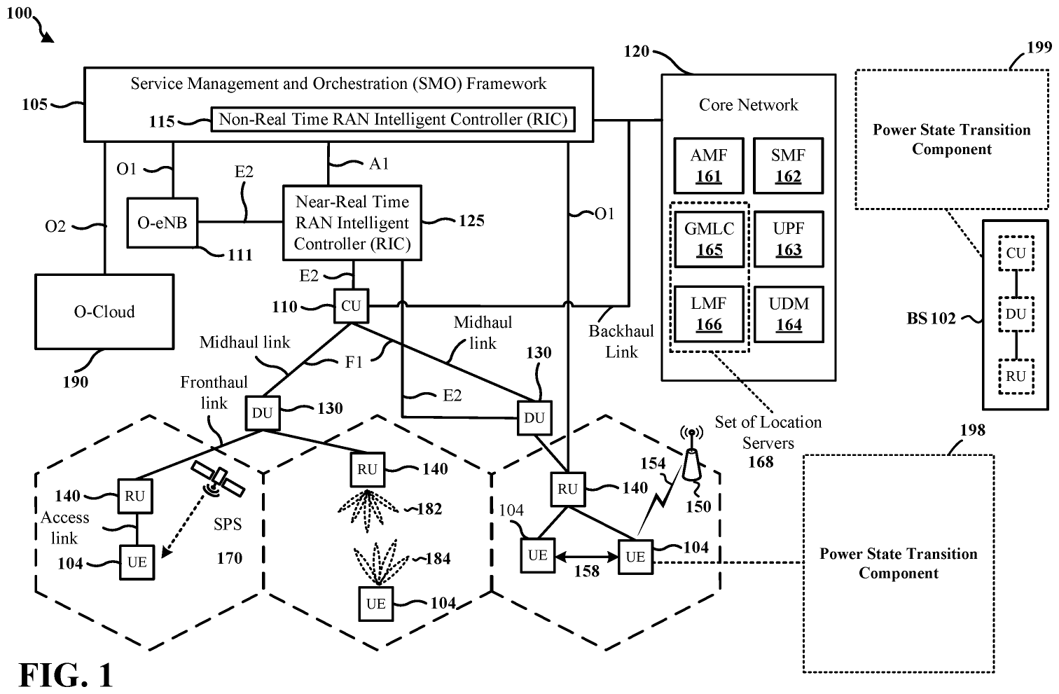

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a power state transition component 198 (“component 198”) that may be configured to receive, from a network node, a downlink DL EOC indication to trigger a status indication. The component 198 may also be configured to transmit, to the network node and based on the DL EOC indication, the status indication indicative of a status of (i) a buffer of the UE or a delay of the UE, and (ii) an estimated time that indicates a time at which the UE estimates an arrival of a next UL packet. The component 198 may be configured to receive, from the network node, a power state switching indication that indicates a mode of operation for the UE based on at least one of the status of the buffer of the UE, the delay of the UE, or the estimated time. The component 198 may be configured to switch to the mode of operation for the UE based on the power state switching indication. The component 198 may be configured to transmit, to the network node, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode based on a second time period. The component 198 may be configured, during a time period after transmitting the status indication and prior to the estimated time, to receive, from the network node, an UL grant for UL traffic associated with data in the buffer of the UE. The component 198 may be configured, during the time period after transmitting the status indication and prior to the estimated time to transmit, for the network node, the UL traffic based on the UL grant. The component 198 may be configured to transmit, for the network node, a capability indication of the UE that indicates at least one of a first capability of the UE to estimate a traffic condition or a second capability of the UE to provide the estimated time. The component 198 may be configured to switch, autonomously by the UE, to a mode of operation for the UE subsequent to transmitting the status indication, where the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a PDCCH. The component 198 may be configured to monitor, while in the mode of operation, for a WUS, from the network node, that includes a sequence type. The component 198 may be configured to receive, from the network node, the WUS that includes the sequence type. The component 198 may be configured to switch to another of the first mode, the second mode, the third mode, or the fourth mode for the UE based on the sequence type. In certain aspects, the base station 102 may have a power state transition component 199 (“component 199”) that may be configured to transmit, to a UE, a DL EOC indication to trigger a status indication. The component 199 may also be configured to receive, from the UE and based on the DL EOC indication, the status indication indicative of a status of (i) a buffer of the UE or a delay of the UE, and (ii) an estimated time that indicates a time at which the UE estimates an arrival of a next UL packet. The component 199 may be configured to transmit, to the UE, a power state switching indication that indicates a mode of operation for the UE based on at least one of the status of the buffer of the UE, the delay of the UE, or the estimated time. The component 199 may be configured to receive, from the UE, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode wake up based on a second period of time. The component 199 may be configured, during a time period after transmitting the status indication and prior to the estimated time, to transmit, for the UE, an UL grant for UL traffic associated with data in the buffer of the UE. The component 199 may be configured, during the time period after transmitting the status indication and prior to the estimated time, to receive, from the UE, the UL traffic based on the UL grant. The component 199 may be configured to receive, from the UE, a capability indication of the UE that indicates at least one of a first capability of the UE to estimate a traffic condition or a second capability of the UE to provide the estimated time. The component 199 may be configured to receive, from the UE, an operation indication that indicates an autonomous switch in operation of the UE for the third mode or the second mode, where the operation indication is comprised in at least one of UCI, a MAC-CE, or UAI. The component 199 may be configured to transmit, to the UE, a WUS that includes a sequence type, where the sequence type is associated with a switch of the UE to another of the first mode, the second mode, the third mode, or the fourth mode for the UE. That is, aspects herein for on power state transitions improve efficiency of communications and reduce consumption power of devices associated with a wireless network by enhancing status reports to include estimated times for UL data and/or delay reports, further improve efficiency of communications and reduce power consumption of wireless devices, as well as quickly provide UE information to a base station without additional signaling, by utilizing DL EOC indications to trigger status reports, and also allow a UE to autonomously transition to a different power state after providing a status indication to a base station by monitoring of various wake up signals.

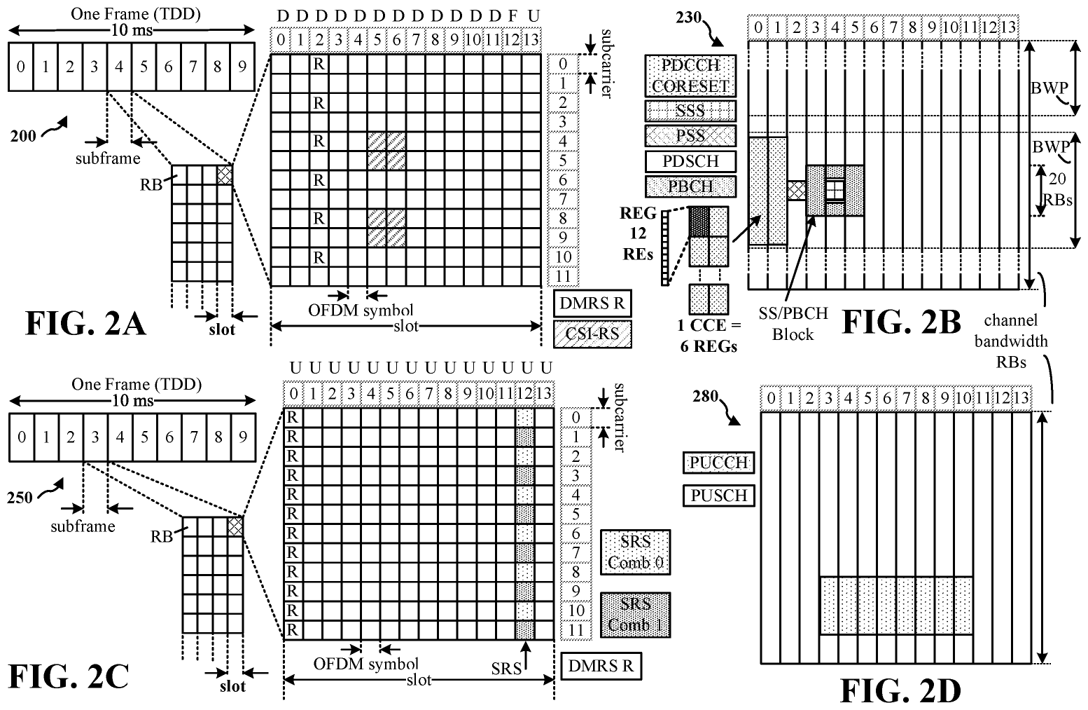

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology p=0 has a subcarrier spacing of 15 kHz and the numerology p=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

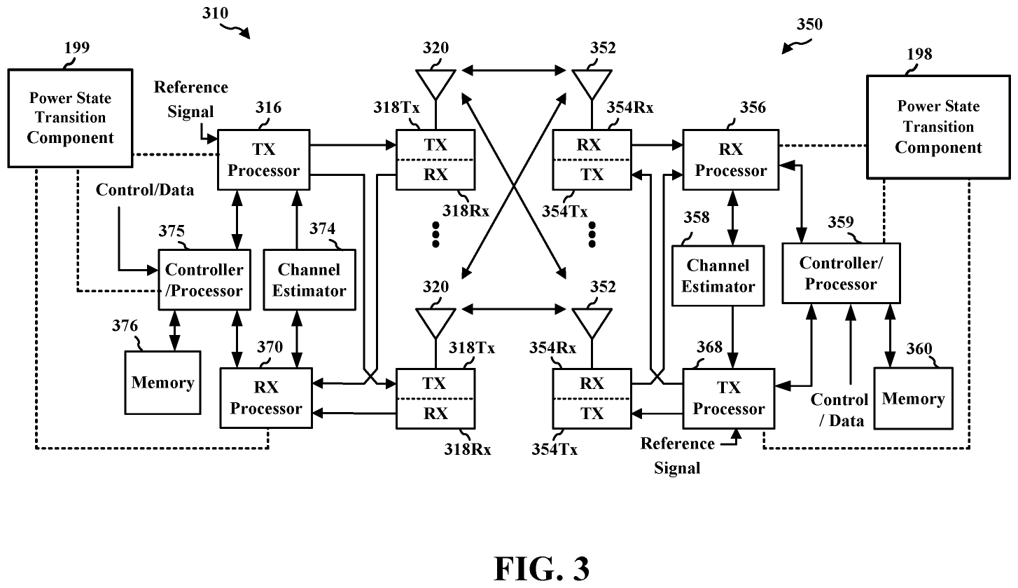

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

Traffic flows in wireless communication networks may have various characteristics in wireless communication networks, e.g., including layer attributes, timeframes for latency, power saving configurations, etc. As an example, XR traffic for UL and DL may have characteristics such as application layer attributes, short timeframes for exchange where longer latency for traffic flows may reduce a user experience with an XR application or device, unbalanced traffic flows, etc. Power saving configurations for XR may include UL states (e.g., without DL communications) triggered by inactivity or express triggers (e.g., via DCI). Other configurations, such as for PDCCH skipping, may save power by allowing a UE skip monitoring for DL PDCCH data/information. PDCCH skipping refers to a UE skipping monitoring for PDCCH for a period of time. Aspects presented herein provide improved granularity with DRX or C-DRX active-inactive states, and C-DRX transitions designed for eMBB/voice traffic in comparison to inactivity timers and enable faster transitions between different power states. Aspects presented herein provide for SSSG state/PDCCH skipping with flexibility that takes quasi-periodic structures into account and provides added granularity of power states (e.g. UL power states without DL monitoring). Further regarding PDCCH skipping, latency may be introduced for UL scheduling as communication (in both UL and DL) may not occur when a UE does not monitor PDCCH. To reduce the UL scheduling latency, a UE may indicate the stop of PDCCH skipping or to override the SSSG switching via the transmission of a SR if the UE has urgent UL data to transmit (e.g., the UE may switch back to regular PDCCH monitoring to monitor uplink grants after sending the SR. Aspects presented herein provide for transitions between power states, such as PDCCH skipping states, even without urgent UL data. In some aspects, a UE may cancel PDCCH skipping, and a base station (e.g., a gNB and/or the like) may have already sent a superfluous PDCCH skipping indication for the UE to go sleep (whether this is scheduling DCI or non-scheduling DCI-a non-scheduling DCI may be in the form of dummy grant with zero resource block allocation and used for indicating PDCCH skipping (e.g., used for nothing else)). Further, a base station (e.g., a gNB and/or the like) may not have awareness/information that a UE is going to send a positive SR so close to a PDCCH skipping indication, which may also warrant the base station to send a superfluous indication. Accordingly, aspects presented herein provide improvements by which a base station (e.g., a gNB and/or the like) may be aware/have information that there is UL data coming soon enough that the base station may make better decisions on whether to send skipping indications or not. Aspects herein provide solutions that cover transitions in an out of power states.

Various aspects herein for power state transitions improve efficiency of communications and reduce consumption power of devices associated with a wireless network by enhancing status reports to include estimated times (also estimated times of arrival (ETAs)) for UL data and/or delay reports. Aspects also further improve efficiency of communications and reduce power consumption of wireless devices, as well as quickly provide UE information to a base station without additional signaling, by utilizing DL EOC indications to trigger status reports. The aspects reduce latency for communication while avoiding additional overhead. Some aspects also enable a UE to autonomously transition to a different power state after providing a status indication to a base station by monitoring various wake up signals.

The aspects herein provide a variety of enhancements to enable fast power state transitions, e.g., for an XR device. Traffic models show rapid switching between states for UL traffic (no DL traffic), DL traffic (no UL traffic), and UL and DL traffic. Therefore, new PHY/MAC signaling is proposed for aspects herein that consider the BSR and estimated time of arrival in the UL to improve power performance. Moreover, new signaling in the DL to fast transition the UE from a certain power state is provided. Aspects include multiple specific design schemes presented herein. Accordingly, the aspects herein relate to state transitions and designs therefor. Aspects include new BSR triggers based on receiving DL EOCs/indications thereof. Aspects also provide for enhancing BSRs to include new information to assist the power state transitions. This new information, for example, may be the estimated time of arrival for UL transmissions. Aspects further allow for a UE to autonomously transition to, or make recommendations of being in, certain power states and leveraging wake up signals (e.g., WUS (generally), a low power WUS (LP-WUS), etc.) for various state transitions.

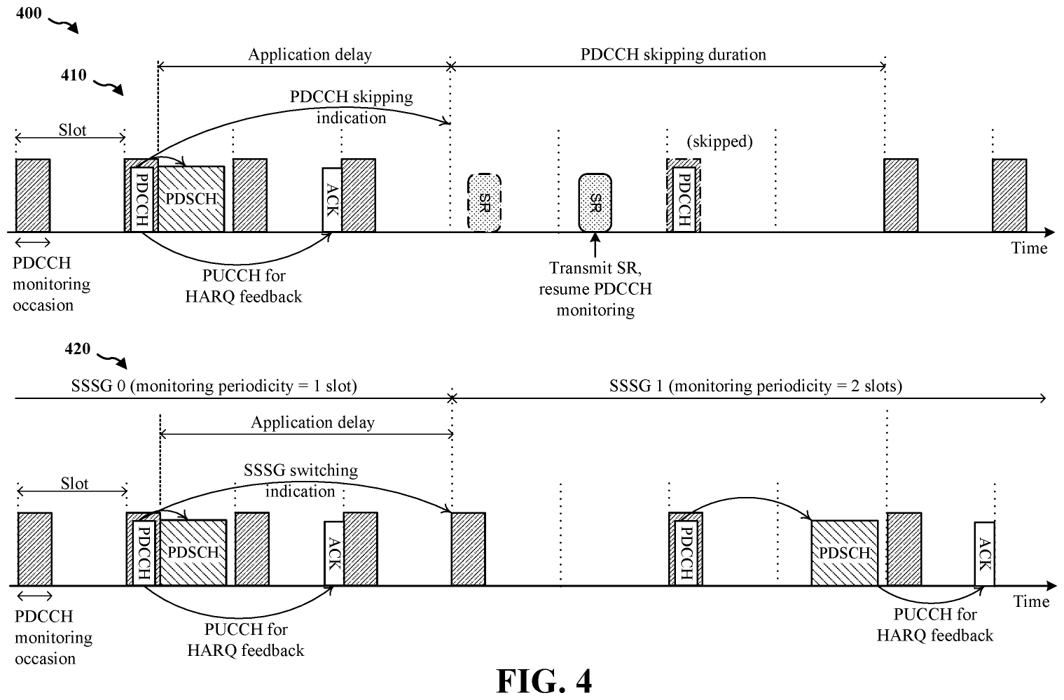

FIG. 4 is a diagram 400 illustrating an example of an SR that overrides, e.g., indicates or requests a cancellation of, PDCCH skipping and SSSG switching. Diagram 400 shows a configuration 410 associated with PDCCH skipping, and a UE sending an SR to override, cancel, or request a cancellation of the PDCCH skipping. Diagram 400 shows a configuration 420 associated with SSSG switching. PDCCH skipping can save power at the UE when the UE does not monitor for the PDCCH. The skipped PDCCH monitoring can increase latency, e.g., because no communications (in both UL and DL) may occur when a UE does not monitor for the PDCCH. To reduce the UL scheduling latency, a UE may indicate or request to stop the PDCCH skipping and to resume PDCCH monitoring, as shown for the configuration 410, or similarly to stop or change the SSSG switching, via the transmission of a SR. As an example, the UE may transmit an SR if the UE has urgent UL data, as shown for the configuration 420. The UE may switch back to regular PDCCH monitoring to monitor for an uplink grant in order to transmit the UL data after sending the SR.

As shown for the configuration 410, when the PDCCH monitoring adaptation field indicates to a UE to skip PDCCH monitoring for a duration on the active DL BWP of a serving cell, the UE starts skipping of PDCCH monitoring at the beginning of a first slot that is after the last symbol of the PDCCH reception providing the DCI format with the PDCCH monitoring adaptation field. If the UE transmits a PUCCH providing a positive SR after the UE detects a DCI format providing the PDCCH monitoring adaptation field indicating to the UE to skip PDCCH monitoring for the duration on the active DL BWP of the serving cell, the UE resumes PDCCH monitoring starting at the beginning of a first slot that is after a last symbol of the PUCCH transmission in all serving cells of the corresponding cell group. Analogously, as shown for the configuration 420, when an SSSG switching indication is received via PDCCH, a UE may override the switching of the SSSG.

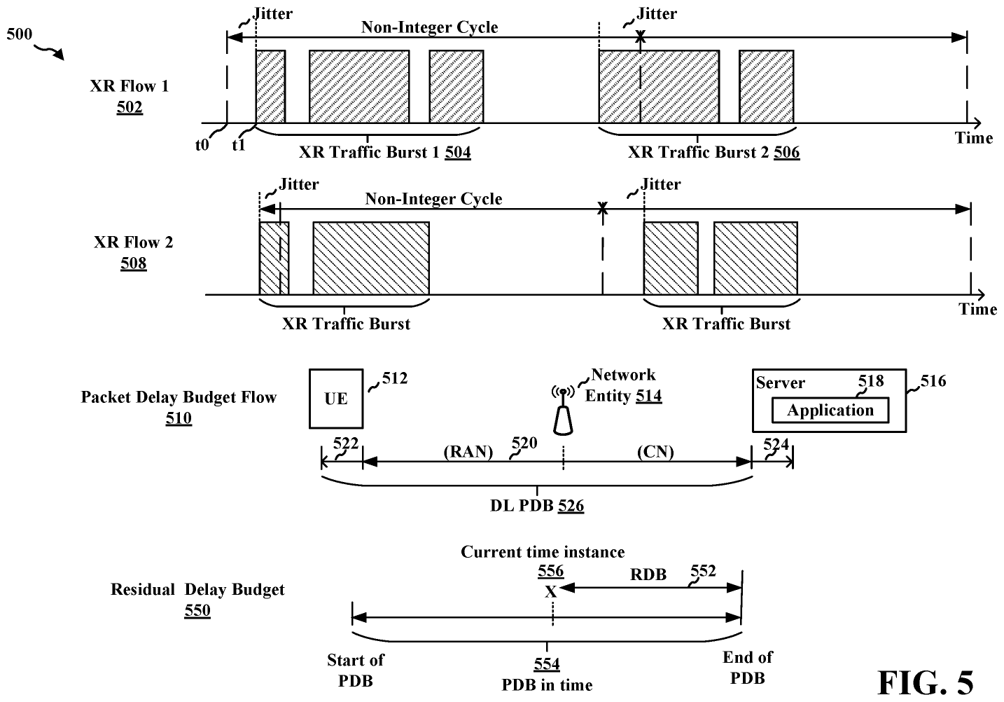

FIG. 5 is a diagram 500 illustrating example XR traffic, in various aspects. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 500 illustrates a first XR flow 502 that includes a first XR traffic burst 504 and a second XR traffic burst 506. As illustrated in the diagram 500, the traffic bursts may include different numbers of packets, e.g., the first XR traffic burst 504 being shown with three packets (represented as rectangles in the diagram 500) and the second XR traffic burst 506 being shown with two packets. Furthermore, as illustrated in the diagram 500, the three packets in the first XR traffic burst 504 and the two packets in the second XR traffic burst 506 may vary in size, that is, packets within the first XR traffic burst 504 and the second XR traffic burst 506 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 502, a UE may expect a first packet of the first XR traffic burst 504 to arrive at time t0, but the first packet of the first XR traffic burst 504 arrives at a time t1, as shown.

XR traffic may include multiple flows that arrive at a UE (or a base station) concurrently with one another (or within a threshold period of time). For instance, the diagram 500 includes a second XR flow 508. The second XR flow 508 may have different characteristics than the first XR flow 502. For instance, the second XR flow 508 may have XR traffic bursts with different numbers of packets, different sizes of packets, etc. In an example, the first XR flow 502 may include video data and the second XR flow 508 may include audio data for the video data. In another example, the first XR flow 502 may include intra-coded picture frames (I-frames) that include complete images and the second XR flow 508 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the RDB at the UE may be unaccounted for in consideration of discarding packets. An example time diagram 550 shows a length of time corresponding to a PDB 554. At a particular point in time 556, the residual delay budget 552 is the remaining portion of the PDB 554.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 500 includes a packet delay budget flow 510. Packet delay budget flow 510 illustrates a UE 512, a network entity 514 (e.g., a base station or portion thereof), and a server 516 that hosts an application 518. In the illustrated aspect, a communication delay 520 is shown as including a RAN portion between the UE 512 and the network entity 514, as well as a CN portion between the network entity 514 and the server 516. The communication delay 520 may apply to both UL and DL communications. Additionally, a residual delay 522 is shown at the UE 512 for DL communications and a residual delay 524 is shown at the server 516 for UL communications. The communication delay 520 and the residual delay 522 may make up an overall PDB for DL XR communications, e.g., DL PDB 526. Likewise, the communication delay 520 and the residual delay 524 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

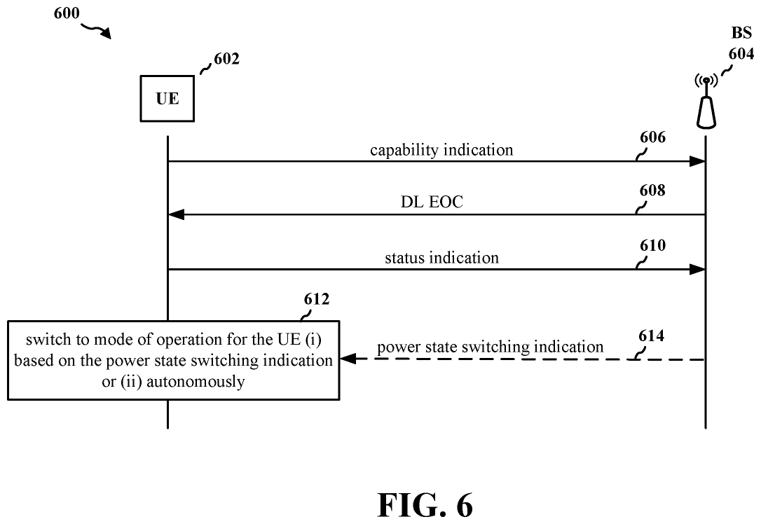

FIG. 6 is a call flow diagram 600 for wireless communications, in various aspects. Call flow diagram 600 illustrates configurations on power state transitions by a UE (e.g., a UE 602) that may communicate with a network node (a base station 604, such as a gNB or other type of base station, by way of example, as shown). Aspects described for the base station 604 may be performed by the base station in aggregated form and/or by one or more components of the base station 604 in disaggregated form. Additionally, or alternatively, the aspects may be performed by the UE 602 autonomously, in addition to, and/or in lieu of, operations of the base station 604.

In the illustrated aspect, the UE 602 may be configured to provide, to the base station 604, a capability indication 606. The capability indication 606 may be associated with at least one of a first capability of the UE for provision of information to the base station 604 for on power state transitions. In aspects, the capability indication 606 may indicate such capabilities of the UE as a first capability of the UE to estimate a traffic condition and/or a second capability of the UE to provide the estimated time. The UE may alternatively provide an estimated time of the grant and/or size of the grant.

The UE 602 may be configured to receive a DL EOC indication 608, and the base station 604 may be configured to provide/transmit the DL EOC indication 608. The DL EOC indication 608 may serve as an indication/signaling for the UE 602 to transition to another power state. The DL EOC indication 608 may be included in/may comprise a portion of a DL communication, such as data provided/transmitted from the base station 604 via a DL channel. The DL EOC indication 608 may be at least one of an end of burst (EOB) indication, a PDCCH skipping indication, a DRX MAC-CE, a DL end of retransmissions indication, a DL feedback indication (DFI) that indicates an ACK for UL packets (e.g., an ACK from a base station/gNB that all UL packets are decoded successfully), and/or any equivalent DL signaling that indicates the UE 602 has finished DL communications. As another example, the EOC indication 608 may be the L1/L2 signaling of an end of cell DRX/DRX active time. In aspects, the DL EOC indication 608 may trigger the UE 602 to provide/transmit a status indication 610 of the UE 602 to the base station 604. The status indication 610 may include/indicate, without limitation, a status of a buffer of the UE (e.g., a BSR such as one comprised in a MAC-CE), a delay status or delay status report (DSR), an estimated time that indicates a time at which the UE 602 estimates an arrival of a next UL packet, and/or the like. In aspects, the DSR may be transmitted together with, or as part of, the BSR.

The UE 602 may be configured to switch (at 612) to a mode of operation for the UE 602 based on a power state switching indication 614 and/or autonomously by the UE 602 subsequent to transmitting the status indication 610. In aspects, the UE 602 may switch (at 612) power states based on the power state switching indication 614, or the UE 602 may autonomously switch (at 612) power states subsequent to transmitting the status indication 610, into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode.

In aspects for which the switch (at 612) is based on the power state switching indication 614, the power state switching indication 614 may be based on, or associated with, the DL EOC indication 608. The power state switching indication 614 may be comprised in DCI, and may indicate for the UE 602 to operate in the third mode based on (i) an amount of data in the buffer of the UE 602 being zero or (ii) a capability of the UE 602 to delay transmission of a data packet, and/or for the UE 602 to operate in the second mode based on the amount of data in the buffer of the UE 602 being non-zero. In such aspects, the UE 602 may be configured to provide/transmit the status indication 610, for the base station 604, that indicates the status of the buffer based on the estimated time. The estimated time may indicate that the time at which the UE 602 estimates the arrival of the next UL packet is shorter than a sleep time to be utilized for the UE 602 to enter a sleep mode. Further, the power state switching indication 614 provided/transmitted from the base station 604 may indicate the mode of operation for the UE 602 as the second mode, in aspects. Additionally, the UE 602 may transmit, to the base station 604, UCI that includes a codepoint for the UE 602. The codepoint for the UE 602 may indicate a first indication to delay operating in a second mode, the second mode consuming less power than a first mode, a second indication that operation in the second mode is acceptable, a third indication to operate in the second mode based on a first time period elapsing, a fourth indication to return to the first mode or transition to a third mode based on a second time period, and/or the like. In aspects, the UCI may be based on and/or in response to the received DL EOC indication 608 from the base station 604.

In aspects for which the switch (at 612) is autonomously performed by the UE 602, the UE 602 may be configured to switch (at 612), autonomously, to the various modes of operation. The modes of operation may be (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), (v) a fifth mode in which the UE 602 is configured to operate in the DL mode and not in the UL mode, and/or the like. In aspects, the UE 602 may be configured to transmit, for the base station 604, an operation indication that indicates operation of the UE 602 for the third mode or the second mode. The operation indication may be comprised in at least one of UCI, a MAC-CE, or UAI, in aspects. The UE 602 may be configured to monitor, while in the mode of operation (e.g., to which the UE 602 autonomously switched), for a WUS (e.g., a WUS generally, a LP-WUS, etc.), from the base station 604, that includes a sequence type. For instance, in aspects, the UE 602 may autonomously transition to a certain power state when DL DCIs are monitored by the UE 602 (e.g., to avoid the UE 602 missing any DL grants in DL data that has arrived for the UE 602). As another example, in some aspects, if the UE 602 is allowed to switch to a power state that does not force the UE 602 to monitor for DL DCIs, the UE 602 may be configured to monitor, while in the mode of operation, for a WUS from the base station 604. The UE 602 may also be configured to receive, from the base station 604, the WUS that includes the sequence type, and to switch to another of the first mode, the second mode, the third mode, or the fourth mode for the UE 602 based on the sequence type. In aspects, the sequence type may be (i) a first sequence type that indicates for the UE 602 to wake up and operate in a fifth mode in which the UE 602 is configured to operate in the DL mode and not in the UL mode, (ii) a second sequence type that indicates for the UE 602 to restart retransmission times for retransmission monitoring, (iii) a third sequence type that indicates for the UE 602 to wake up and operate in the second mode, (iv) a fourth sequence type that includes a payload of bits in the WUS, where the payload of bits corresponds to the first sequence type, the second sequence type, or the third sequence type, (iv) a fifth mode in which the UE 602 is configured to operate in the DL mode and not in the UL mode, and/or the like.

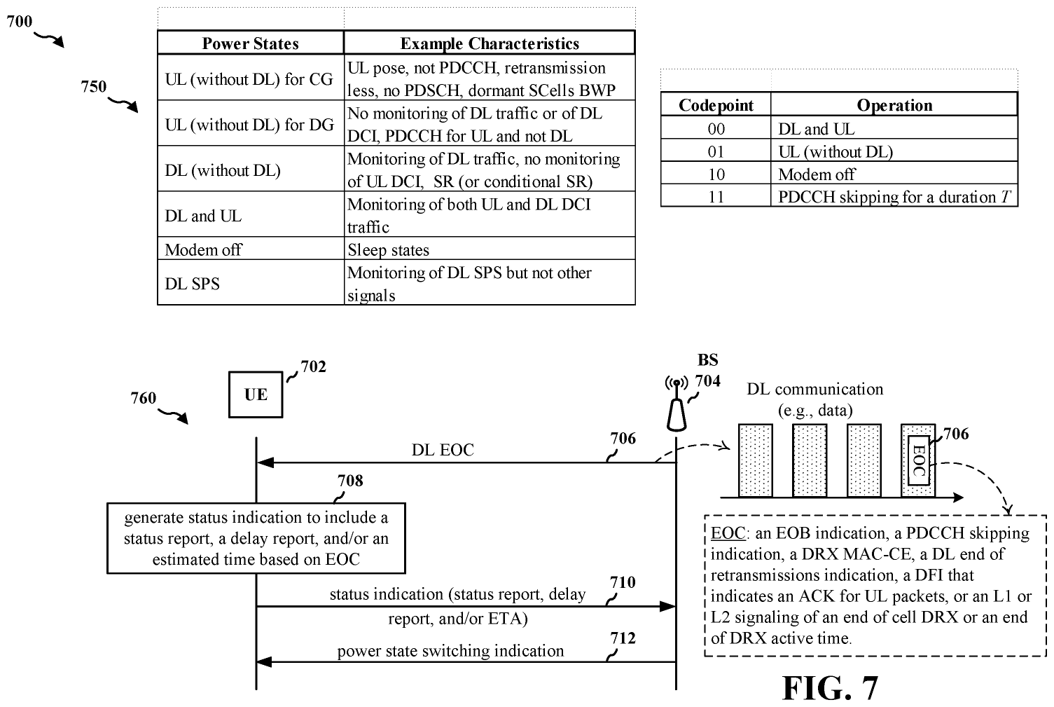

FIG. 7 is a diagram 700 illustrating a configuration 750 of example power states and associated codepoints, as well as a call flow diagram 760 for wireless communications, in various aspects for on power state transitions.

The configuration 750 shows power states and corresponding example characteristics, as well as associated codepoints and their corresponding operations, without limitation. As a first example, an UL power state is shown (e.g., without DL) for configured grants (CGs), which includes monitoring for UL pose, not PDCCH, that is without retransmissions, with no PDSCH monitoring, and with dormant SCell BWPs. As a second example, an UL power state is shown (e.g., without DL) for dynamic grants (DG), which includes no monitoring of DL traffic, no monitoring of DL DCI, and monitoring of PDCCH for UL and not DL. As a third example, a DL power state is shown (e.g., without DL), which includes monitoring of DL traffic, no monitoring of UL DCI or SRs (or conditional SRs). As a fourth example, a DL and UL power state is shown, which includes monitoring of both UL and DL DCI traffic. As a fifth example, a modem off power state is shown, which includes one or more sleep states for a UE. As a sixth example, a DL SPS power state is shown, which includes monitoring of DL SPS but not other signals.

Associated with the power states described above are codepoints and operations for a UE. For instance, a codepoint of ‘00’ may be associated with the DL and UL power state for the UE, a codepoint of ‘01’ may be associated with the UL power state (e.g., no DL monitoring) for the UE, a codepoint of ‘10’ may be associated with the modem off power state for the UE, and a codepoint of ‘ 11’ may be associated with a PDCCH skipping power state/mode for the UE. Accordingly, the codepoint representations may indicate for a UE and/or a base station that the UE is to switch to, is in, or desires to be in, a given power state. It should be noted that the codepoints are shown and described in the configuration 750 by way of example and not limitation, and that other power states/operations may be associated with additional codepoints and/or in lieu of those for the codepoints shown.

The call flow diagram 760 is shown for wireless communications between a UE 702 and a base station 704, and may be a further aspect of the call flow diagram 600 described above for FIG. 6.

The UE 702 may be configured to receive a DL EOC indication 706, and the base station 704 may be configured to provide/transmit the DL EOC indication 706. The DL EOC indication 706 may be included in/may comprise a portion of a DL communication, such as data provided/transmitted from the base station 704 via a DL channel. In aspects, the DL EOC indication 706 may trigger the UE 702 to generate and/or provide/transmit a status indication 710 of the UE 702 to the base station 704. The DL EOC indication 706 may be at least one of an EOB indication, a PDCCH skipping indication, a DRX MAC-CE, a DL end of retransmissions indication, a DFI that indicates an ACK for UL packets (e.g., an ACK from a base station/gNB that all UL packets are decoded successfully), and/or any equivalent DL signaling that indicates the UE 702 has finished DL communications. As another example, the EOC indication 706 may be the L1/L2 signaling of an end of cell DRX/DRX active time. The UE may generate (at 708) the status indication 710 based on and/or in response to the received DL EOC indication 706. The status indication 710 may include/indicate, without limitation, a status of a buffer of the UE (e.g., a BSR such as one comprised in a MAC-CE), a delay status or delay status report (DSR), an estimated time that indicates a time at which the UE 702 estimates an arrival of a next UL packet, and/or the like. The UE 702 may be configured to provide/transmit the status indication 710 of the UE 702, which may be received by the base station 704, based on the triggering caused by the DL EOC indication 706.

The UE 702 may be configured to switch (as described above) to a mode of operation for the UE 702 based on a power state switching indication 712 provided/transmitted by the base station 704. The power state switching indication 712 may be comprised in DCI, and may indicate for the UE 702 to operate in the third mode based on (i) an amount of data in the buffer of the UE 702 being zero or (ii) a capability of the UE 702 to delay transmission of a data packet, and/or for the UE 702 to operate in the second mode based on the amount of data in the buffer of the UE 702 being non-zero.

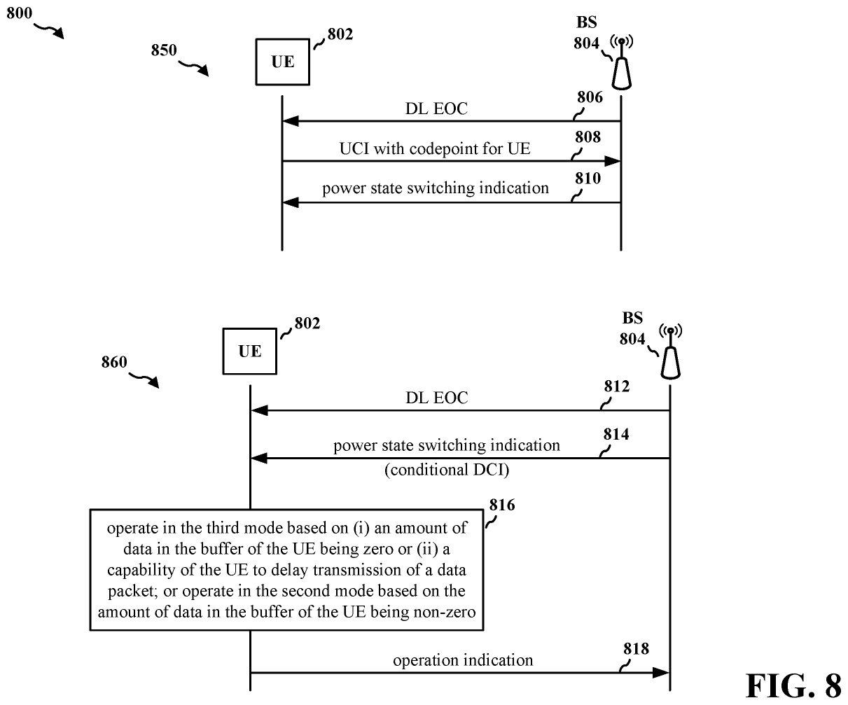

FIG. 8 is a diagram 800 illustrating example UCI codepoints and conditional DCI for power states, in various aspects. Diagram 800 shows a call flow diagram 850 and a call flow diagram 860 for wireless communications with respect to a UE 802 and a base station 804. The call flow diagram 850 and/or the call flow diagram 860 may be further aspects of the call flow diagram 600 described above for FIG. 6.

In the call flow diagram 850, the UE 802 may be configured to receive a DL EOC indication 806, and the base station 804 may be configured to provide/transmit the DL EOC indication 806. The DL EOC indication 806 may be included in/may comprise a portion of a DL communication, such as data provided/transmitted from the base station 804 via a DL channel, and may be a further aspects of the DL EOC indication 608 in FIG. 6 and/or the DL EOC indication 706 in FIG. 6.

The UE 802 may be configured to provide/transmit UCI 808, which the base station 804 may be configured to receive. The UCI 808 may be provided/transmitted by the UE 802 based on, or in response to, the received DL EOC indication 806. The UCI 808 may include a codepoint for the UE 802 that indicates (i) a first indication to delay operating in a second mode, the second mode consuming less power than a first mode, (ii) a second indication that operation in the second mode is acceptable, (iii) a third indication to operate in the second mode based on a first time period elapsing, (iv) a fourth indication to return to the first mode or transition to a third mode based on a second time period, and/or the like. Accordingly, in aspects, the base station 804 may be configured to provide/transmit a power state switching indication 810 based on the UCI 808 with the codepoint, which may be received by the UE 802.

Through the power state switching indication 810, the base station 804, in a first example, may trigger a status indication (e.g., BSR, delay status, and/or estimated time), or the DL EOC indication 806 may trigger the status indication, as described herein, if the status indication indicates that the buffer of the UE 802 is non-zero and/or that the UE 802 is delay intolerant. The UE 802 may not be sent to sleep via the power state switching indication 810, but instead the UE 802 may be sent to an UL power state (e.g., no monitoring of DL traffic), which is of a lower power than a DL and UL power state. Through the power state switching indication 810, the base station 804, in a second example, may trigger a status indication (e.g., BSR, delay status, and/or estimated time) if the status indication indicates that the buffer of the UE 802 is zero and the estimated time for arrival of a next UL data packet is not sufficient to enter a sleep mode (e.g., it may be inefficient (such as in terms of DCI bits) for UE 802 to go to sleep, micro sleep, deep sleep, ultra-deep sleep, etc., and then transition from sleep to an on state (e.g., non-sleep states of the power states for the configuration 750 in FIG. 7). A configurable threshold for the estimated time may be configured such that if estimated time is less than, or less than or equal to, the threshold, then the UE 802 is not sent to sleep. Through the power state switching indication 810, the base station 804, in a third example, may trigger a status indication (e.g., BSR, delay status, and/or estimated time) if the status indication indicates that the buffer of the UE 802 is zero and the estimated time is long enough for the UE 802 to enter a sleep state, the UE 802 may be sent to sleep until the estimated time, and the UE 802 may sleep according to the available time. The time to transition to another power state may also be considered to make the decision of which sleep state the UE 802 is to enter, in aspects.

In some aspects, even if the base station/network node does not have the status indication, as described herein, the base station/network node may send a conditional DCI indication to the UE for power state transitions.

In the call flow diagram 860, the UE 802 may be configured to receive a DL EOC indication 812, and the base station 804 may be configured to provide/transmit the DL EOC indication 812. The DL EOC indication 812 may be included in/may comprise a portion of a DL communication, such as data provided/transmitted from the base station 804 via a DL channel, and may be a further aspects of the DL EOC indication 608 in FIG. 6 and/or the DL EOC indication 706 in FIG. 6. In the illustrated aspect, the base station 804 may not receive a status indication, as described herein, from the UE 802. The base station 804, however, may be configured to provide/transmit a power state switching indication 814, e.g., as a conditional DCI, to the UE 802 in the absence of the status indication.

The UE 802 may be configured to switch (as described above) to a mode of operation for the UE 802 based on the power state switching indication 814 provided/transmitted by the base station 804. The power state switching indication 814 may be comprised in a conditional DCI, and may indicate for the UE 802 to, as a first option, (i) go to a sleep state if the amount of data waiting in the buffer of the UE 802 is zero, or (ii) the UE 802 may safely wait for next cycle to transmit packet because the UE 802 is configured to be delay tolerant. As a second option, the UE 802 may go to an UL power state/mode (e.g., no DL traffic monitoring) if an amount of data waiting in the buffer of the UE 802 is non-zero. In aspects, the UE 802 may be configured to report (e.g., provide/transmit) back to the base station 804 (e.g., receive) which of the two states/modes it will be in (e.g., an operational state 818 of the UE 802) via UCI, MAC-CE, or UAI. In aspects, RRC signaling such as UAI may include a recommendation from the UE 802 for the periodicity of the power states preferred (e.g., the UE 802 may have better information of its UL traffic than the base station 804 when there is cross-layer optimization between the application and the modem of the UE 802).

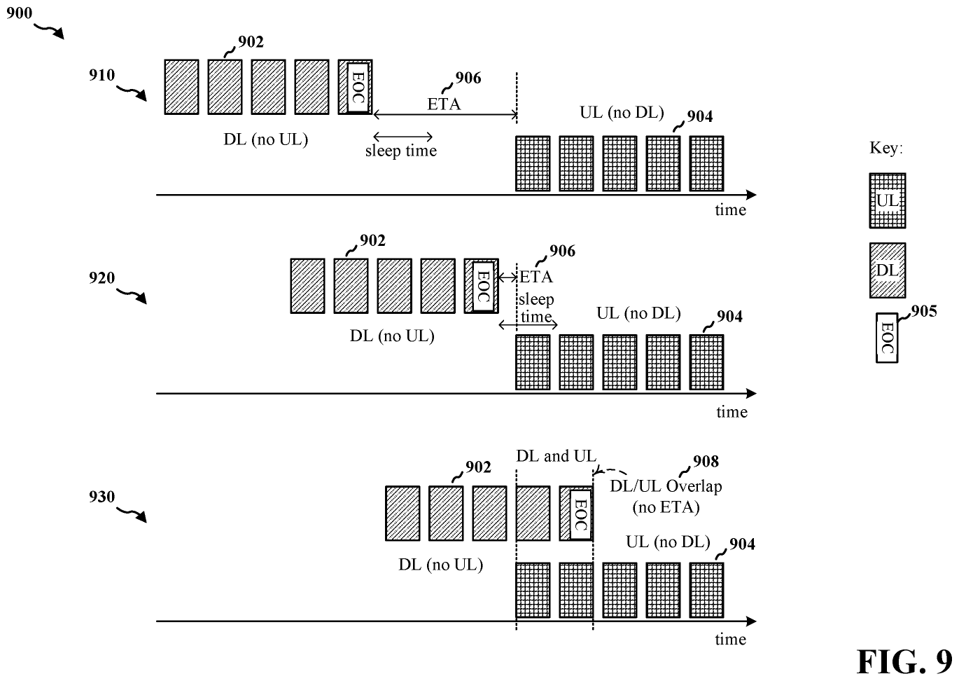

FIG. 9 is a diagram 900 illustrating examples for DL and UL transmissions associated with power states and estimated times (or ETAs), in various aspects. Diagram 900 shows a configuration 910, a configuration 920, and a configuration 930 in the context of transmissions for a set of DL data 902 (e.g., a DL burst) and a set of UL data 904 (e.g., an UL burst) relative to an estimated time 906 (“ETA”). In aspects, the set of DL data 902 may include a DL EOC indication 905, as described herein.

In the example for configuration 910, a UE initially operates in a power state for DL traffic monitoring (e.g., without UL traffic monitoring). The set of DL data 902 ends and the DL EOC indication 905 is received by the UE. In the example for configuration 910, the estimated time 906, which the UE estimates for the arrival of the next UL packet, is not shorter (e.g., is longer) than a sleep time to be utilized for the UE to enter a sleep mode such as microsleep (“usleep”), deep sleep, ultra-deep sleep, and/or the like. Accordingly, the UE is sent to sleep while it waits for the set of UL data 904 (e.g., the next UL packet). In aspects, when the set of UL data 904 arrives, the UE may wake up and enter an UL power state to transmit the set of UL data 904 (e.g., the second mode, described above, in which the UE is configured to operate in the UL mode and not in the DL mode). As noted herein, the UE may provide/transmit the estimated time 906, as well as a buffer status and/or a delay status, to a base station/network node.

In the example for configuration 920, a UE initially operates in a power state for DL traffic monitoring (e.g., without UL traffic monitoring). The set of DL data 902 ends and the DL EOC indication 905 is received by the UE. In the example for configuration 920, the estimated time 906, which the UE estimates for the arrival of the next UL packet, is shorter than a sleep time to be utilized for the UE to enter a sleep mode such as microsleep (“usleep”), deep sleep, ultra-deep sleep, and/or the like. That is, the ETA estimated time in the example for configuration 920 may indicate that there is not enough time for the UE to enter a sleep mode prior to the arrival of the set of UL data 904. Accordingly, the UE may not be sent to sleep while it waits for the set of UL data 904 (e.g., the next UL packet), but may enter/transition to an UL power state to transmit the set of UL data 904 (e.g., the second mode, described above, in which the UE is configured to operate in the UL mode and not in the DL mode). As noted herein, the UE may provide/transmit the estimated time 906, as well as a buffer status (such as a BSR) and/or a delay status, to a base station/network node. In aspects, the UE may send the BSR if the UE does not want to sleep, e.g., because the estimated time 906 is too short to allow sleep, which may avoid having the UE send a superfluous BSR.

In the example for configuration 930, a UE initially operates in a power state for DL traffic monitoring (e.g., without UL traffic monitoring). In the configurations 910/920, when the set of DL data 902 ends, the DL EOC indication 905 is received by the UE to trigger an estimation of the estimated time 906 (as well as buffer/delay status, in aspects). In the example for configuration 930, the estimated time 906 may or may not be estimated, in aspects, as the set of UL data 904 has already arrived and there is a DL/UL overlap 908 with the set of DL data 902. Accordingly, the UE may not be sent to sleep, but may enter/transition to a DL and UL power state to transmit the set of UL data 904 while receiving the set of DL data 902 (e.g., the first mode, described above, in which the UE is configured to operate in the UL mode and in the DL mode simultaneously-in aspects, this may be based on a received PUCCH that indicates a positive SR). When the set of DL data 902 ends, the buffer of the UE is non-zero because the set of UL data 904 has already arrived. Accordingly, the UE may not be sent to sleep, but may enter/transition to an UL power state to continue transmission of the set of UL data 904.

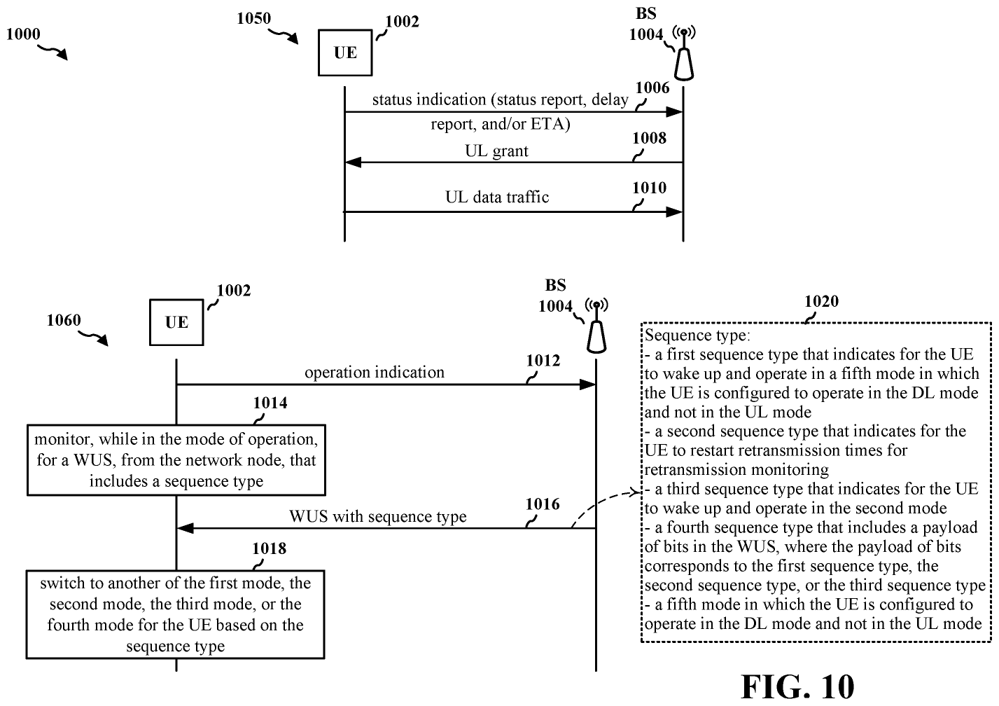

FIG. 10 is a diagram 1000 illustrating example UL grant handling after status indications and wake up signal monitoring for autonomous power state transitions, in various aspects. Diagram 1000 shows a call flow diagram 1050 and a call flow diagram 1060 for wireless communications with respect to a UE 1002 and a base station 1004. The call flow diagram 1050 and/or the call flow diagram 1060 may be further aspects of the call flow diagram 600 described above for FIG. 6.

As described herein, a UE may enter various modes of operation/power states in association with receiving DL EOC indications. Aspect, however, also provide for a UE to handle grants and transmit UL data packets for traffic in the UE buffer as reported by a status indication (e.g., via a BSR).

In the call flow diagram 1050, subsequent to receiving a DL EOC indication, as noted herein, the UE 1002 may be configured to provide/transmit a status indication 1006 which may be received by the base station 1004. The status indication 1006 may include, without limitation, a buffer status (e.g., a BSR), a delay status, an estimated time, and/or the like. In scenarios for which the buffer of the UE 1002 is non-zero and there are data packets to transmit via UL channels, the UE 1002 may be configured to receive from the base station 1004 at least one UL grant 1008, and in response, to provide associated UL data traffic 1010 to the base station 1004.

The call flow diagram 1060 shows example wireless communications for UE-suggested power state transitions. For instance, after sending an UL EOC indication or zero buffer status report, the UE 1002 may be configured to autonomously transition to which ever state it prefers (e.g., as described above (at 612) for FIG. 6). However, this cause a misunderstanding with base station 1004, which may not be aware of the autonomous transition (e.g., the base station 1004 may believe that the UE 1002 is still monitoring DCIs while the UE 1002 has gone into a low power state/mode such a low power mode for UL traffic and not DL traffic, a low power mode for modem off, a low power mode for a certain sleep state, etc. Consequently, the UE 1002 may miss an UL retransmission, may miss a DL grant, and/or the like.

In such cases, the UE 1002 may be configured to provide/transmit for the base station 1004 an operation indication 1012. The operation indication 1012 may indicate, for the base station 1004, which power state/mode of operation the UE 1002 has autonomously entered (e.g., the first, second, third, fourth, fifth, etc., modes described below). In this manner, the base station 1004 is made aware of the autonomous transition of the UE 1002. While in the desired power state/mode of operation for which the UE 1002 has autonomously entered, the UE 1002 may be configured to monitor (at 1014) for a WUS 1016 (e.g., WUS (generally), a low power WUS (LP-WUS), etc.) with a sequence type, from the base station 1004. The WUS 1016 may include a sequence type 1020.

The UE 1002 may be configured to receive, from the base station 1004, the WUS 1016 with the sequence type 1020. The sequence type 1020 included with/in the WUS may be a first sequence type that indicates for the UE to wake up and operate in a fifth mode in which the UE is configured to operate in the DL mode and not in the UL mode (e.g., if the UE 1002 autonomously made a decision to be in the DL power state, the UE 1002 may remain in the DL power state after this type of WUS; if the UE 1002 autonomously made a decision to be in a UL power state, the UE 1002 may move to the DL power state, and if the UE 1002 autonomously made a decision to be in the DL power state, the UE 1002 may remain in the DL power state after this type of WUS), a second sequence type that indicates for the UE to restart retransmission times for retransmission monitoring, a third sequence type that indicates for the UE to wake up and operate in the second mode (e.g., if the UE 1002 autonomously made a decision to be in the UL power state, the UE 1002 may remain in the UL power state after this type of WUS; if the UE 1002 autonomously made a decision to be in a DL power state, the UE 1002 may move to the UL power state, and if the UE 1002 autonomously made a decision to be in the UL power state, the UE 1002 may remain in the UL power state after this type of WUS), a fourth sequence type that includes a payload of bits in the WUS, where the payload of bits corresponds to the first sequence type, the second sequence type, or the third sequence type, a fifth mode in which the UE is configured to operate in the DL mode and not in the UL mode, and/or the like. Based on the WUS 1016 and the sequence type 1020, the UE 1002 may be configured to switch (at 1018) to another of the first mode, the second mode, the third mode, or the fourth mode for the UE based on the sequence type 1020.

Thus, the UE 1002 is allowed to transition autonomously from a higher power state (e.g., from a DL and UL state) to a lower power states (e.g., an UL power state, a modem off power state, a DL power state), and to accomplish this efficiently, the UE 1002 is configured to monitor (at 1018) for a WUS, a LP-WUS, and/or the like, to transition to a different power state, which may be indicated in the WUS 1016 by the base station 1004. In aspects, the base station 1004 may configure the UE 1002 with a LP-WUS for this purpose when the UE 1002 is allowed to autonomously move to a certain power state.

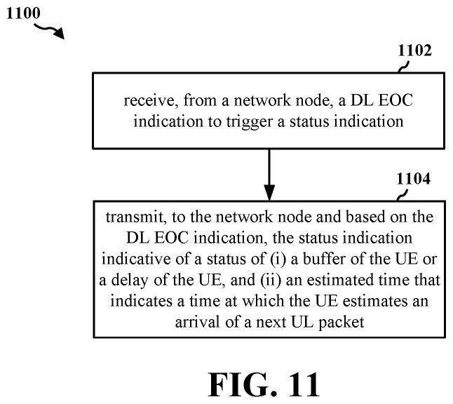

FIG. 11 is a flowchart 1100 of a method of wireless communication. The method may be performed by a UE (e.g., the UE 104, 602, 702, 802, 1002; the apparatus 1504). In some aspects, the method may include aspects described in connection with the communication flow in FIG. 6 and/or aspects described in FIGS. 7-10. The method provides for on power state transitions that enables on power state transitions to improve efficiency of communications and reduce consumption power of devices associated with a wireless network by enhancing status reports to include estimated times for UL data and/or delay reports, further improve efficiency of communications and reduce power consumption of wireless devices, as well as quickly provide UE information to a base station without additional signaling, by utilizing DL EOC indications to trigger status reports, and also allow a UE to autonomously transition to a different power state after providing a status indication to a base station by monitoring of various wake up signals.

At 1102, the UE receives, from a network node, a DL EOC indication to trigger a status indication. As an example, the reception may be performed, at least in part, by the component 198. FIGS. 6-10 illustrate an example of the UE 602 receiving such a DL EOC indication from a network node (e.g., the base station 604).

The UE 602 may be configured to provide, to the base station 604, a capability indication 606. The capability indication 606 may be associated with at least one of a first capability of the UE for provision of information to the base station 604 for on power state transitions. In aspects, the capability indication 606 may indicate such capabilities of the UE as a first capability of the UE to estimate a traffic condition and/or a second capability of the UE to provide the estimated time (e.g., 906, 908 in FIG. 9). The UE 602 may be configured to receive a DL EOC indication 608 (e.g., 706 in FIG. 7; 806, 812 in FIG. 8), and the base station 604 may be configured to provide/transmit the DL EOC indication 608 (e.g., 706 in FIG. 7; 806, 812 in FIG. 8). The DL EOC indication 608 (e.g., 706 in FIG. 7; 806, 812 in FIG. 8) may be included in/may comprise a portion of a DL communication, such as data provided/transmitted from the base station 604 via a DL channel. The DL EOC indication 608 may be at least one of an EOB indication, a PDCCH skipping indication, a DRX MAC-CE, a DL end of retransmissions indication, a DFI that indicates an ACK for UL packets (e.g., an ACK from a base station/gNB that all UL packets are decoded successfully), and/or any equivalent DL signaling that indicates the UE 602 has finished DL communications. As another example, the EOC indication 608 may be the L1/L2 signaling of an end of cell DRX/DRX active time.

At 1104, the UE transmits, to the network node and based on the DL EOC indication, the status indication indicative of a status of (i) a buffer of the UE or a delay of the UE, and (ii) an estimated time that indicates a time at which the UE estimates an arrival of a next UL packet. As an example, the transmission may be performed, at least in part, by the component 198. FIGS. 6-10 illustrate an example of the UE 602 transmitting such a status indication for a network node (e.g., the base station 604).

In aspects, the DL EOC indication 608 (e.g., 706 in FIG. 7; 806, 812 in FIG. 8) may trigger the UE 602 to provide/transmit a status indication 610 (e.g., 710 in FIG. 7; 1006 in FIG. 10) of the UE 602 to the base station 604. The status indication 610 (e.g., 710 in FIG. 7; 1006 in FIG. 10) may include/indicate, without limitation, a status of a buffer of the UE (e.g., a BSR such as one comprised in a MAC-CE), a delay status or delay status report (DSR), an estimated time (e.g., 906, 908 in FIG. 9) that indicates a time at which the UE 602 estimates an arrival of a next UL packet, and/or the like. The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g. 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode (e.g., 750 in FIG. 7; 816 in FIG. 8; 1018 in FIG. 10).

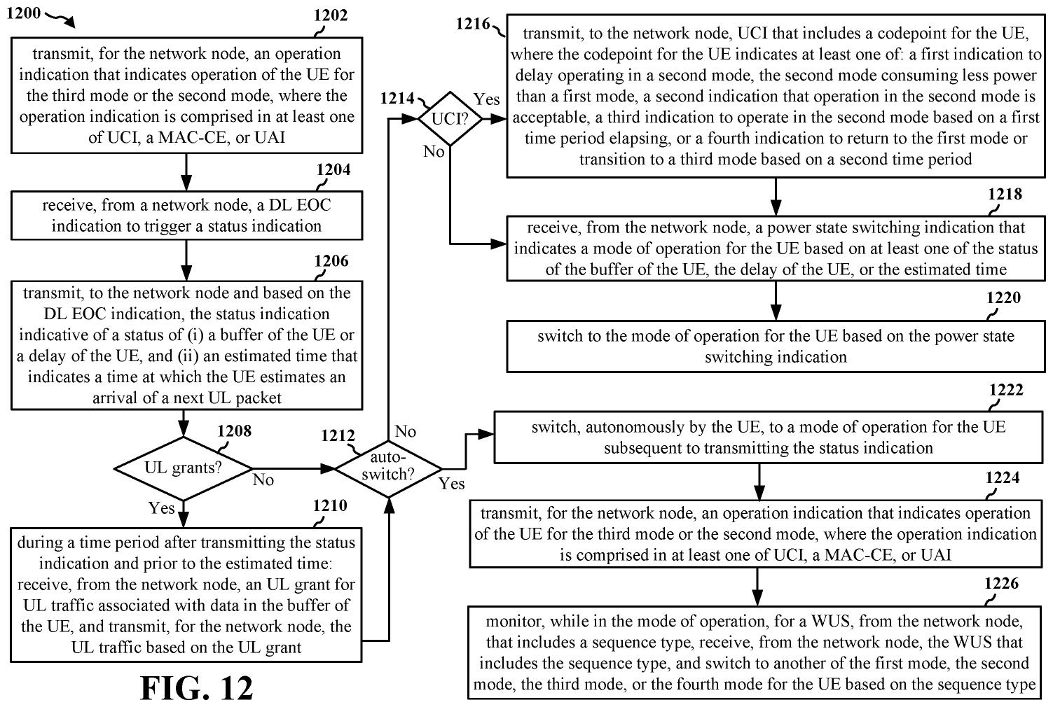

FIG. 12 is a flowchart 1200 of a method of wireless communication. The method may be performed by a UE (e.g., the UE 104, 602, 702, 802, 1002; the apparatus 1504). In some aspects, the method may include aspects described in connection with the communication flow in FIG. 6 and/or aspects described in FIGS. 7-10. The method provides for on power state transitions that enables on power state transitions to improve efficiency of communications and reduce consumption power of devices associated with a wireless network by enhancing status reports to include estimated times for UL data and/or delay reports, further improve efficiency of communications and reduce power consumption of wireless devices, as well as quickly provide UE information to a base station without additional signaling, by utilizing DL EOC indications to trigger status reports, and also allow a UE to autonomously transition to a different power state after providing a status indication to a base station by monitoring of various wake up signals.

At 1202, the UE transmits, for the network node, a capability indication of the UE that indicates at least one of a first capability of the UE to estimate a traffic condition or a second capability of the UE to provide the estimated time. As an example, the transmission may be performed, at least in part, by the component 198. FIGS. 6-10 illustrate an example of the UE 602 transmitting such a capability indication for a network node (e.g., the base station 604).

The UE 602 may be configured to provide, to the base station 604, a capability indication 606. The capability indication 606 may be associated with at least one of a first capability of the UE for provision of information to the base station 604 for on power state transitions. In aspects, the capability indication 606 may indicate such capabilities of the UE as a first capability of the UE to estimate a traffic condition and/or a second capability of the UE to provide the estimated time (e.g., 906, 908 in FIG. 9).

At 1204, the UE receives, from a network node, a DL EOC indication to trigger a status indication. As an example, the reception may be performed, at least in part, by the component 198. FIGS. 6-10 illustrate an example of the UE 602 receiving such a DL EOC indication from a network node (e.g., the base station 604).

The UE 602 may be configured to receive a DL EOC indication 608 (e.g., 706 in FIG. 7; 806, 812 in FIG. 8), and the base station 604 may be configured to provide/transmit the DL EOC indication 608 (e.g., 706 in FIG. 7; 806, 812 in FIG. 8). The DL EOC indication 608 (e.g., 706 in FIG. 7; 806, 812 in FIG. 8) may be included in/may comprise a portion of a DL communication, such as data provided/transmitted from the base station 604 via a DL channel. The DL EOC indication 608 may be at least one of an EOB indication, a PDCCH skipping indication, a DRX MAC-CE, a DL end of retransmissions indication, a DFI that indicates an ACK for UL packets (e.g., an ACK from a base station/gNB that all UL packets are decoded successfully), and/or any equivalent DL signaling that indicates the UE 602 has finished DL communications. As another example, the EOC indication 608 may be the L1/L2 signaling of an end of cell DRX/DRX active time.

At 1206, the UE transmits, to the network node and based on the DL EOC indication, the status indication indicative of a status of (i) a buffer of the UE or a delay of the UE, and (ii) an estimated time that indicates a time at which the UE estimates an arrival of a next UL packet. As an example, the transmission may be performed, at least in part, by the component 198. FIGS. 6-10 illustrate an example of the UE 602 transmitting such a status indication for a network node (e.g., the base station 604).

In aspects, the DL EOC indication 608 (e.g., 706 in FIG. 7; 806, 812 in FIG. 8) may trigger the UE 602 to provide/transmit a status indication 610 (e.g., 710 in FIG. 7; 1006 in FIG. 10) of the UE 602 to the base station 604. The status indication 610 (e.g., 710 in FIG. 7; 1006 in FIG. 10) may include/indicate, without limitation, a status of a buffer of the UE (e.g., a BSR such as one comprised in a MAC-CE), a delay status or delay status report (DSR), an estimated time (e.g., 906, 908 in FIG. 9) that indicates a time at which the UE 602 estimates an arrival of a next UL packet, and/or the like.

At 1208, the UE determines if it awaits UL grants for data to be transmitted from the buffer of the UE. As an example, the determination may be performed, at least in part, by the component 198. If so, flowchart 1200 continues to 1210; if not, flowchart 1200 continues to 1212.

At 1210, the UE, during a time period after transmitting the status indication and prior to the estimated time: receives, from the network node, an UL grant for UL traffic associated with data in the buffer of the UE, and transmits, for the network node, the UL traffic based on the UL grant. As an example, the reception and transmission may be performed, at least in part, by the component 198. FIGS. 6 and 10 illustrate an example of the UE 602 receiving UL grants and transmitting UL data with a network node (e.g., the base station 604).

As described herein, a UE may enter various modes of operation/power states in association with receiving DL EOC indications. Aspect, however, also provide for a UE to handle grants and transmit UL data packets for traffic in the UE buffer as reported by a status indication (e.g., via a BSR). In the call flow diagram 1050, subsequent to receiving a DL EOC indication, as noted herein, the UE 1002 (e.g., 602 in FIG. 6) may be configured to provide/transmit a status indication 1006 which may be received by the base station 1004 (e.g., 604 in FIG. 6). The status indication 1006 may include, without limitation, a buffer status (e.g., a BSR), a delay status, an estimated time (e.g., 906, 908 in FIG. 9), and/or the like. In scenarios for which the buffer of the UE 1002 is non-zero and there are data packets to transmit via UL channels, the UE 1002 may be configured to receive from the base station 1004 at least one UL grant 1008, and in response, to provide associated UL data traffic 1010 to the base station 1004.

At 1212, the UE determines if it will perform autonomous power state switching. As an example, the determination may be performed, at least in part, by the component 198. If so, flowchart 1200 continues to 1222; if not, flowchart 1200 continues to 1214.

At 1214, the UE determines if it will provide/transmit UCI with a codepoint of the UE for the network node. As an example, the determination may be performed, at least in part, by the component 198. If so, flowchart 1200 continues to 1216; if not, flowchart 1200 continues to 1218.

At 1216, the UE transmits, to the network node, UCI that includes a codepoint for the UE, where the codepoint for the UE indicates at least one of: a first indication to delay operating in a second mode, the second mode consuming less power than a first mode, a second indication that operation in the second mode is acceptable, a third indication to operate in the second mode based on a first time period elapsing, or a fourth indication to return to the first mode or transition to a third mode based on a second time period. As an example, the transmission may be performed, at least in part, by the component 198. FIGS. 6 and 8 illustrate an example of the UE 602 transmitting such UCI for a network node (e.g., the base station 604).

The UE 602 may be configured to transmit, to the base station 604, UCI (e.g., 808 in FIG. 8) that includes a codepoint (e.g., 750 in FIG. 7) for the UE 602. The UCI 808 may be provided/transmitted based on, or in response to, the received DL EOC indication 608 (e.g., 706 in FIG. 7; 806, 812 in FIG. 8). The codepoint (e.g., 750 in FIG. 7) for the UE 602 may indicate a first indication to delay operating in a second mode, the second mode consuming less power than a first mode, a second indication that operation in the second mode is acceptable, a third indication to operate in the second mode based on a first time period elapsing, a fourth indication to return to the first mode or transition to a third mode based on a second time period, and/or the like. In aspects, the UCI (e.g., 808 in FIG. 8) may be based on and/or in response to the received DL EOC indication 608 (e.g., 706 in FIG. 7; 806, 812 in FIG. 8) from the base station 604.

At 1218, the UE receives, from the network node, a power state switching indication that indicates a mode of operation for the UE based on at least one of the status of the buffer of the UE, the delay of the UE, or the estimated time. As an example, the reception may be performed, at least in part, by the component 198. FIGS. 6-10 illustrate an example of the UE 602 receiving such a power state switching indication from a network node (e.g., the base station 604).

The UE 602 may receive the power state switching indication 614 (e.g., 712 in FIG. 7; 810, 814 in FIG. 8) that is provided/transmitted from the base station 604. In the context of FIG. 7, the power state switching indication 712 provided/transmitted by the base station 704 may be comprised in DCI, and may indicate for the UE 702 to operate in the third mode based on (i) an amount of data in the buffer of the UE 702 being zero or (ii) a capability of the UE 702 to delay transmission of a data packet, and/or for the UE 702 to operate in the second mode based on the amount of data in the buffer of the UE 702 being non-zero. In the context of FIG. 8 (850), the base station 804 may be configured to provide/transmit a power state switching indication 810 based on the UCI 808 with the codepoint, which may be received by the UE 802. Through the power state switching indication 810, the base station 804, in a first example, may trigger a status indication (e.g., BSR, delay status, and/or estimated time (e.g., 906, 908 in FIG. 9)), or the DL EOC indication 806 may trigger the status indication, as described herein, if the status indication indicates that the buffer of the UE 802 is non-zero and/or that the UE 802 is delay intolerant. The UE 802 may not be sent to sleep via the power state switching indication 810, but instead the UE 802 may be sent to an UL power state (e.g., no monitoring of DL traffic), which is of a lower power than a DL and UL power state. Through the power state switching indication 810, the base station 804, in a second example, may trigger a status indication (e.g., BSR, delay status, and/or estimated time) if the status indication indicates that the buffer of the UE 802 is zero and the estimated time (e.g., 906, 908 in FIG. 9) for arrival of a next UL data packet is not sufficient to enter a sleep mode (e.g., it may be inefficient (such as in terms of DCI bits) for UE 802 to go to sleep, micro sleep, deep sleep, ultra-deep sleep, etc., and then transition from sleep to an on state (e.g., non-sleep states of the power states for the configuration 750 in FIG. 7). A configurable threshold for the estimated time (e.g., 906, 908 in FIG. 9) may be configured such that if estimated time (e.g., 906, 908 in FIG. 9) is less than, or less than or equal to, the threshold, then the UE 802 is not sent to sleep. Through the power state switching indication 810, the base station 804, in a third example, may trigger a status indication (e.g., BSR, delay status, and/or estimated time (e.g., 906, 908 in FIG. 9)) if the status indication indicates that the buffer of the UE 802 is zero and the estimated time (e.g., 906, 908 in FIG. 9) is long enough for the UE 802 to enter a sleep state, the UE 802 may be sent to sleep until the estimated time (e.g., 906, 908 in FIG. 9), and the UE 802 may sleep according to the available time. The time to transition to another power state may also be considered to make the decision of which sleep state the UE 802 is to enter, in aspects. In some aspects, even if the base station/network node does not have the status indication, as described herein, the base station/network node may send a conditional DCI indication to the UE for power state transitions. In the context of FIG. 8 (860), the power state switching indication 814 may be comprised in a conditional DCI, and may indicate for the UE 802 to, as a first option, (i) go to a sleep state if the amount of data waiting in the buffer of the UE 802 is zero, or (ii) the UE 802 may safely wait for next cycle to transmit packet because the UE 802 is configured to be delay tolerant. As a second option, the UE 802 may go to an UL power state/mode (e.g., no DL traffic monitoring) if an amount of data waiting in the buffer of the UE 802 is non-zero. In aspects, the UE 802 may be configured to report (e.g., provide/transmit) back to the base station 804 (e.g., receive) which of the two states/modes it will be in (e.g., an operational state 818 of the UE 802) via UCI, MAC-CE, or UAI. In aspects, RRC signaling such as UAI may include a recommendation from the UE 802 for the periodicity of the power states preferred (e.g., the UE 802 may have better information of its UL traffic than the base station 804 when there is cross-layer optimization between the application and the modem of the UE 802).

At 1220, the UE switches to the mode of operation for the UE based on the power state switching indication. As an example, the switching may be performed, at least in part, by the component 198. FIGS. 6-10 illustrate an example of the UE 602 switching such power states based on a power state switching indication from a network node (e.g., the base station 604).

The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g., 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode.

In aspects for which the switch (at 612) is based on the power state switching indication 614 (e.g., 712 in FIG. 7; 810, 814 in FIG. 8), the power state switching indication 614 (e.g., 712 in FIG. 7; 810, 814 in FIG. 8) may be based on, or associated with, the DL EOC indication 608. The power state switching indication 614 (e.g., 712 in FIG. 7; 810, 814 in FIG. 8) may be comprised in DCI, and may indicate for the UE 602 to operate in the third mode based on (i) an amount of data in the buffer of the UE 602 being zero or (ii) a capability of the UE 602 to delay transmission of a data packet, and/or for the UE 602 to operate in the second mode based on the amount of data in the buffer of the UE 602 being non-zero. In such aspects, the UE 602 may be configured to provide/transmit the status indication 610 (e.g., 710 in FIG. 7; 1006 in FIG. 10), for the base station 604, that indicates the status of the buffer based on the estimated time (e.g., 906, 908 in FIG. 9). The estimated time (e.g., 906, 908 in FIG. 9) may indicate that the time at which the UE 602 estimates the arrival of the next UL packet is shorter than a sleep time to be utilized for the UE 602 to enter a sleep mode. Further, the power state switching indication 614 provided/transmitted for the base station 604 may indicate the mode of operation for the UE 602 as the second mode, in aspects. Additionally, the UE 602 may transmit, to the base station 604, UCI that includes a codepoint for the UE 602. The codepoint for the UE 602 may indicate a first indication to delay operating in a second mode, the second mode consuming less power than a first mode, a second indication that operation in the second mode is acceptable, a third indication to operate in the second mode based on a first time period elapsing, a fourth indication to return to the first mode or transition to a third mode based on a second time period, and/or the like. In aspects, the UCI may be based on and/or in response to the received DL EOC indication 608 from the base station 604.

At 1222, the UE switches, autonomously by the UE, to a mode of operation for the UE subsequent to transmitting the status indication. As an example, the switching may be performed, at least in part, by the component 198. FIGS. 6-10 illustrate an example of the UE 602 autonomously switching such power states.

The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g., 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode.

In aspects for which the switch (at 612) is autonomously performed (e.g., 1060 in FIG. 10) by the UE 602, the UE 602 may be configured to switch (at 612), autonomously (e.g., 1060 in FIG. 10), to the various modes of operation. The modes of operation may be (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), (v) a fifth mode in which the UE 602 is configured to operate in the DL mode and not in the UL mode, and/or the like.

At 1224, the UE transmits, for the network node, an operation indication that indicates operation of the UE for the third mode or the second mode, where the operation indication is comprised in at least one of UCI, a MAC-CE, or UAI. As an example, the transmission may be performed, at least in part, by the component 198. FIGS. 6-10 illustrate an example of the UE 602 transmitting such an operation indication for a network node (e.g., the base station 604).

In aspects, the UE 602 may be configured to transmit, for the base station 604, an operation indication (e.g., 818 in FIG. 8; 1012 in FIG. 10) that indicates operation of the UE 602 for the third mode or the second mode. The operation indication (e.g., 818 in FIG. 8; 1012 in FIG. 10) may be comprised in at least one of UCI, a MAC-CE, or UAI, in aspects. In the context of FIG. 10, the UE 1002 (e.g., 602 in FIG. 6) may be configured to provide/transmit for the base station 1004 (e.g., 1004) an operation indication 1012. The operation indication 1012 may indicate, for the base station 1004, which power state/mode of operation the UE 1002 has autonomously entered (e.g., the first, second, third, fourth, fifth, etc., modes described below). In this manner, the base station 1004 is made aware of the autonomous transition of the UE 1002. While in the desired power state/mode of operation for which the UE 1002 has autonomously entered.

At 1226, the UE monitors, while in the mode of operation, for a WUS, from the network node, that includes a sequence type, receives, from the network node, the WUS that includes the sequence type, and switches to another of the first mode, the second mode, the third mode, or the fourth mode for the UE based on the sequence type. As an example, the monitoring, the reception, and/or the switching may be performed, at least in part, by the component 198. FIGS. 6-10 illustrate an example of the UE 602 performing such monitoring, receiving, and switching transmitting in association with a network node (e.g., the base station 604).

The UE 602 may be configured to monitor (e.g., at 1014 in FIG. 10), while in the mode of operation (e.g., to which the UE 602 autonomously switched), for a WUS (e.g., a WUS generally, a LP-WUS, etc.) (e.g., 1016 in FIG. 10), from the base station 604, that includes a sequence type (e.g., 1020 in FIG. 10). The UE 602 may also be configured to receive, from the base station 604, the WUS (e.g., 1016 in FIG. 10) that includes the sequence type (e.g., 1020 in FIG. 10), and to switch (e.g., at 1018 in FIG. 10) to another of the first mode, the second mode, the third mode, or the fourth mode for the UE 602 based on the sequence type (e.g., 1020 in FIG. 10). In aspects, the sequence type (e.g., 1020 in FIG. 10) may be (i) a first sequence type that indicates for the UE 602 to wake up and operate in a fifth mode in which the UE 602 is configured to operate in the DL mode and not in the UL mode, (ii) a second sequence type that indicates for the UE 602 to restart retransmission times for retransmission monitoring, (iii) a third sequence type that indicates for the UE 602 to wake up and operate in the second mode, (iv) a fourth sequence type that includes a payload of bits in the WUS, where the payload of bits corresponds to the first sequence type, the second sequence type, or the third sequence type, (iv) a fifth mode in which the UE 602 is configured to operate in the DL mode and not in the UL mode, and/or the like.

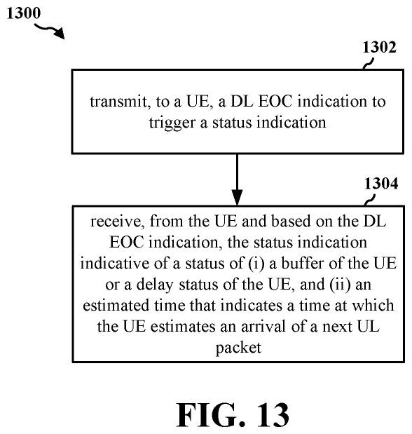

FIG. 13 is a flowchart 1300 of a method of wireless communication. The method may be performed by a base station/gNB (e.g., the base station 102, 604, 704, 804, 1004; the network entity 1502, 1602, _1260). In some aspects, the method may include aspects described in connection with the communication flow in FIG. 6 and/or aspects described in FIGS. 7-10. The method provides for on power state transitions that enables on power state transitions to improve efficiency of communications and reduce consumption power of devices associated with a wireless network by enhancing status reports to include estimated times for UL data and/or delay reports, further improve efficiency of communications and reduce power consumption of wireless devices, as well as quickly provide UE information to a base station without additional signaling, by utilizing DL EOC indications to trigger status reports, and also allow a UE to autonomously transition to a different power state after providing a status indication to a base station by monitoring of various wake up signals.

At 1302, the base station transmits, to a UE, a DL EOC indication to trigger a status indication. As an example, the transmission may be performed, at least in part, by the component 199. FIGS. 6-10 illustrate an example of the base station 604 transmitting such a DL EOC indication for a UE (e.g., the UE 602).

The UE 602 may be configured to provide, to the base station 604, a capability indication 606. The capability indication 606 may be associated with at least one of a first capability of the UE for provision of information to the base station 604 for on power state transitions. In aspects, the capability indication 606 may indicate such capabilities of the UE as a first capability of the UE to estimate a traffic condition and/or a second capability of the UE to provide the estimated time (e.g., 906, 908 in FIG. 9). The UE 602 may be configured to receive a DL EOC indication 608 (e.g., 706 in FIG. 7; 806, 812 in FIG. 8), and the base station 604 may be configured to provide/transmit the DL EOC indication 608 (e.g., 706 in FIG. 7; 806, 812 in FIG. 8). The DL EOC indication 608 (e.g., 706 in FIG. 7; 806, 812 in FIG. 8) may be included in/may comprise a portion of a DL communication, such as data provided/transmitted from the base station 604 via a DL channel. The DL EOC indication 608 may be at least one of an EOB indication, a PDCCH skipping indication, a DRX MAC-CE, a DL end of retransmissions indication, a DFI that indicates an ACK for UL packets (e.g., an ACK from a base station/gNB that all UL packets are decoded successfully), and/or any equivalent DL signaling that indicates the UE 602 has finished DL communications. As another example, the EOC indication 608 may be the L1/L2 signaling of an end of cell DRX/DRX active time.

At 1304, the base station receives, from the UE and based on the DL EOC indication, the status indication indicative of a status of (i) a buffer of the UE or a delay of the UE, and (ii) an estimated time that indicates a time at which the UE estimates an arrival of a next UL packet. As an example, the reception may be performed, at least in part, by the component 199. FIGS. 6-10 illustrate an example of the base station 604 receiving such a status indication from a UE (e.g., the UE 602).

In aspects, the DL EOC indication 608 (e.g., 706 in FIG. 7; 806, 812 in FIG. 8) may trigger the UE 602 to provide/transmit a status indication 610 (e.g., 710 in FIG. 7; 1006 in FIG. 10) of the UE 602 to the base station 604. The status indication 610 (e.g., 710 in FIG. 7; 1006 in FIG. 10) may include/indicate, without limitation, a status of a buffer of the UE (e.g., a BSR such as one comprised in a MAC-CE), a delay status or delay status report (DSR), an estimated time (e.g., 906, 908 in FIG. 9) that indicates a time at which the UE 602 estimates an arrival of a next UL packet, and/or the like. The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g. 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode (e.g., 750 in FIG. 7; 816 in FIG. 8; 1018 in FIG. 10).

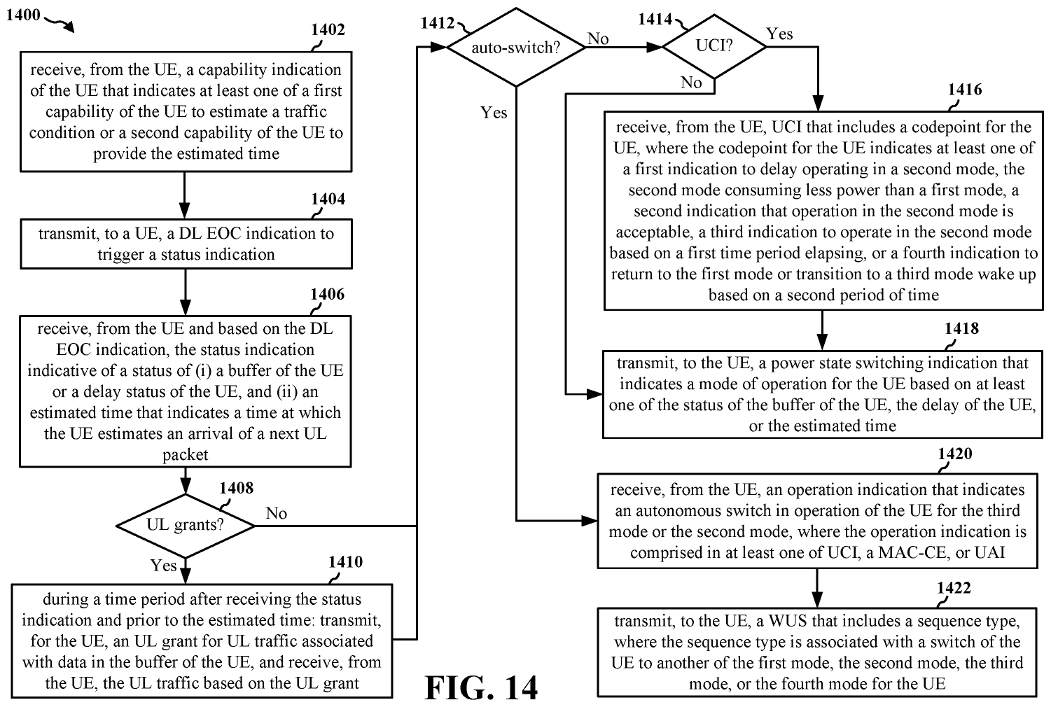

FIG. 14 is a flowchart 1400 of a method of wireless communication. The method may be performed by a base station/gNB (e.g., the base station 102, 604, 704, 804, 1004; the network entity 1502, 1602, _1260). In some aspects, the method may include aspects described in connection with the communication flow in FIG. 6 and/or aspects described in FIGS. 7-10. The method provides for on power state transitions that enables on power state transitions to improve efficiency of communications and reduce consumption power of devices associated with a wireless network by enhancing status reports to include estimated times for UL data and/or delay reports, further improve efficiency of communications and reduce power consumption of wireless devices, as well as quickly provide UE information to a base station without additional signaling, by utilizing DL EOC indications to trigger status reports, and also allow a UE to autonomously transition to a different power state after providing a status indication to a base station by monitoring of various wake up signals.

At 1402, the base station receives, from the UE, a capability indication of the UE that indicates at least one of a first capability of the UE to estimate a traffic condition or a second capability of the UE to provide the estimated time. As an example, the reception may be performed, at least in part, by the component 199. FIGS. 6-10 illustrate an example of the base station 604 receiving such a capability indication from a UE (e.g., the UE 602).

The UE 602 may be configured to provide, to the base station 604, a capability indication 606. The capability indication 606 may be associated with at least one of a first capability of the UE for provision of information to the base station 604 for on power state transitions. In aspects, the capability indication 606 may indicate such capabilities of the UE as a first capability of the UE to estimate a traffic condition and/or a second capability of the UE to provide the estimated time (e.g., 906, 908 in FIG. 9).

At 1404, the base station transmits, to a UE, a DL EOC indication to trigger a status indication. As an example, the transmission may be performed, at least in part, by the component 199. FIGS. 6-10 illustrate an example of the base station 604 transmitting such a DL EOC indication for a UE (e.g., the UE 602).

The UE 602 may be configured to receive a DL EOC indication 608 (e.g., 706 in FIG. 7; 806, 812 in FIG. 8), and the base station 604 may be configured to provide/transmit the DL EOC indication 608 (e.g., 706 in FIG. 7; 806, 812 in FIG. 8). The DL EOC indication 608 (e.g., 706 in FIG. 7; 806, 812 in FIG. 8) may be included in/may comprise a portion of a DL communication, such as data provided/transmitted from the base station 604 via a DL channel. The DL EOC indication 608 may be at least one of an EOB indication, a PDCCH skipping indication, a DRX MAC-CE, a DL end of retransmissions indication, a DFI that indicates an ACK for UL packets (e.g., an ACK from a base station/gNB that all UL packets are decoded successfully), and/or any equivalent DL signaling that indicates the UE 602 has finished DL communications. As another example, the EOC indication 608 may be the L1/L2 signaling of an end of cell DRX/DRX active time.

At 1406, the base station receives, from the UE and based on the DL EOC indication, the status indication indicative of a status of (i) a buffer of the UE or a delay of the UE, and (ii) an estimated time that indicates a time at which the UE estimates an arrival of a next UL packet. As an example, the reception may be performed, at least in part, by the component 199. FIGS. 6-10 illustrate an example of the base station 604 receiving such a status indication from a UE (e.g., the UE 602).

In aspects, the DL EOC indication 608 (e.g., 706 in FIG. 7; 806, 812 in FIG. 8) may trigger the UE 602 to provide/transmit a status indication 610 (e.g., 710 in FIG. 7; 1006 in FIG. 10) of the UE 602 to the base station 604. The status indication 610 (e.g., 710 in FIG. 7; 1006 in FIG. 10) may include/indicate, without limitation, a status of a buffer of the UE (e.g., a BSR such as one comprised in a MAC-CE), a delay status or delay status report (DSR), an estimated time (e.g., 906, 908 in FIG. 9) that indicates a time at which the UE 602 estimates an arrival of a next UL packet, and/or the like.

At 1408, the base station determines if it will provide UL grants for data to be transmitted from the buffer of the UE. As an example, the determination may be performed, at least in part, by the component 199. If so, flowchart 1400 continues to 1410; if not, flowchart 1400 continues to 1412.

At 1410, the base station, during a time period after receiving the status indication and prior to the estimated time: transmits, for the UE, an UL grant for UL traffic associated with data in the buffer of the UE, and receives, from the UE, the UL traffic based on the UL grant. As an example, the transmission and reception may be performed, at least in part, by the component 199. FIGS. 6 and 10 illustrate an example of the base station 604 transmitting UL grants and receiving UL data with a UE (e.g., the UE 602).

As described herein, a UE may enter various modes of operation/power states in association with receiving DL EOC indications. Aspect, however, also provide for a UE to handle grants and transmit UL data packets for traffic in the UE buffer as reported by a status indication (e.g., via a BSR). In the call flow diagram 1050, subsequent to receiving a DL EOC indication, as noted herein, the UE 1002 (e.g., 602 in FIG. 6) may be configured to provide/transmit a status indication 1006 which may be received by the base station 1004 (e.g., 604 in FIG. 6). The status indication 1006 may include, without limitation, a buffer status (e.g., a BSR), a delay status, an estimated time (e.g., 906, 908 in FIG. 9), and/or the like. In scenarios for which the buffer of the UE 1002 is non-zero and there are data packets to transmit via UL channels, the UE 1002 may be configured to receive from the base station 1004 at least one UL grant 1008, and in response, to provide associated UL data traffic 1010 to the base station 1004.

At 1412, the base station determines if the UE performs autonomous power state switching. As an example, the determination may be performed, at least in part, by the component 199. If so, flowchart 1400 continues to 1420; if not, flowchart 1400 continues to 1414.

At 1414, the base station determines if the UE provides/transmits UCI with a codepoint of the UE. As an example, the determination may be performed, at least in part, by the component 199. If so, flowchart 1400 continues to 1416; if not, flowchart 1400 continues to 1418.

At 1416, the base station receives, from the UE, UCI that includes a codepoint for the UE, where the codepoint for the UE indicates at least one of a first indication to delay operating in a second mode, the second mode consuming less power than a first mode, a second indication that operation in the second mode is acceptable, a third indication to operate in the second mode based on a first time period elapsing, or a fourth indication to return to the first mode or transition to a third mode wake up based on a second period of time. As an example, the reception may be performed, at least in part, by the component 199. FIGS. 6 and 8 illustrate an example of the base station 604 receiving such UCI from a UE (e.g., the UE 602).

The UE 602 may be configured to transmit, to the base station 604, UCI (e.g., 808 in FIG. 8) that includes a codepoint (e.g., 750 in FIG. 7) for the UE 602. The UCI 808 may be provided/transmitted based on, or in response to, the received DL EOC indication 608 (e.g., 706 in FIG. 7; 806, 812 in FIG. 8). The codepoint (e.g., 750 in FIG. 7) for the UE 602 may indicate a first indication to delay operating in a second mode, the second mode consuming less power than a first mode, a second indication that operation in the second mode is acceptable, a third indication to operate in the second mode based on a first time period elapsing, a fourth indication to return to the first mode or transition to a third mode based on a second time period, and/or the like. In aspects, the UCI (e.g., 808 in FIG. 8) may be based on and/or in response to the received DL EOC indication 608 (e.g., 706 in FIG. 7; 806, 812 in FIG. 8) from the base station 604.

At 1418, the base station transmits, to the UE, a power state switching indication that indicates a mode of operation for the UE based on at least one of the status of the buffer of the UE, the delay of the UE, or the estimated time. As an example, the transmission may be performed, at least in part, by the component 199. FIGS. 6-10 illustrate an example of the base station 604 transmitting such a power state switching indication for a UE (e.g., the UE 602).

The UE 602 may receive the power state switching indication 614 (e.g., 712 in FIG. 7; 810, 814 in FIG. 8) that is provided/transmitted from the base station 604. In the context of FIG. 7, the power state switching indication 712 provided/transmitted by the base station 704 may be comprised in DCI, and may indicate for the UE 702 to operate in the third mode based on (i) an amount of data in the buffer of the UE 702 being zero or (ii) a capability of the UE 702 to delay transmission of a data packet, and/or for the UE 702 to operate in the second mode based on the amount of data in the buffer of the UE 702 being non-zero. In the context of FIG. 8 (850), the base station 804 may be configured to provide/transmit a power state switching indication 810 based on the UCI 808 with the codepoint, which may be received by the UE 802. Through the power state switching indication 810, the base station 804, in a first example, may trigger a status indication (e.g., BSR, delay status, and/or estimated time (e.g., 906, 908 in FIG. 9)), or the DL EOC indication 806 may trigger the status indication, as described herein, if the status indication indicates that the buffer of the UE 802 is non-zero and/or that the UE 802 is delay intolerant. The UE 802 may not be sent to sleep via the power state switching indication 810, but instead the UE 802 may be sent to an UL power state (e.g., no monitoring of DL traffic), which is of a lower power than a DL and UL power state. Through the power state switching indication 810, the base station 804, in a second example, may trigger a status indication (e.g., BSR, delay status, and/or estimated time) if the status indication indicates that the buffer of the UE 802 is zero and the estimated time (e.g., 906, 908 in FIG. 9) for arrival of a next UL data packet is not sufficient to enter a sleep mode (e.g., it may be inefficient (such as in terms of DCI bits) for UE 802 to go to sleep, micro sleep, deep sleep, ultra-deep sleep, etc., and then transition from sleep to an on state (e.g., non-sleep states of the power states for the configuration 750 in FIG. 7). A configurable threshold for the estimated time (e.g., 906, 908 in FIG. 9) may be configured such that if estimated time (e.g., 906, 908 in FIG. 9) is less than, or less than or equal to, the threshold, then the UE 802 is not sent to sleep. Through the power state switching indication 810, the base station 804, in a third example, may trigger a status indication (e.g., BSR, delay status, and/or estimated time (e.g., 906, 908 in FIG. 9)) if the status indication indicates that the buffer of the UE 802 is zero and the estimated time (e.g., 906, 908 in FIG. 9) is long enough for the UE 802 to enter a sleep state, the UE 802 may be sent to sleep until the estimated time (e.g., 906, 908 in FIG. 9), and the UE 802 may sleep according to the available time. The time to transition to another power state may also be considered to make the decision of which sleep state the UE 802 is to enter, in aspects. In some aspects, even if the base station/network node does not have the status indication, as described herein, the base station/network node may send a conditional DCI indication to the UE for power state transitions. In the context of FIG. 8 (860), the power state switching indication 814 may be comprised in a conditional DCI, and may indicate for the UE 802 to, as a first option, (i) go to a sleep state if the amount of data waiting in the buffer of the UE 802 is zero, or (ii) the UE 802 may safely wait for next cycle to transmit packet because the UE 802 is configured to be delay tolerant. As a second option, the UE 802 may go to an UL power state/mode (e.g., no DL traffic monitoring) if an amount of data waiting in the buffer of the UE 802 is non-zero. In aspects, the UE 802 may be configured to report (e.g., provide/transmit) back to the base station 804 (e.g., receive) which of the two states/modes it will be in (e.g., an operational state 818 of the UE 802) via UCI, MAC-CE, or UAI. In aspects, RRC signaling such as UAI may include a recommendation from the UE 802 for the periodicity of the power states preferred (e.g., the UE 802 may have better information of its UL traffic than the base station 804 when there is cross-layer optimization between the application and the modem of the UE 802).

The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g., 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode.

In aspects for which the switch (at 612) is based on the power state switching indication 614 (e.g., 712 in FIG. 7; 810, 814 in FIG. 8), the power state switching indication 614 (e.g., 712 in FIG. 7; 810, 814 in FIG. 8) may be based on, or associated with, the DL EOC indication 608. The power state switching indication 614 (e.g., 712 in FIG. 7; 810, 814 in FIG. 8) may be comprised in DCI, and may indicate for the UE 602 to operate in the third mode based on (i) an amount of data in the buffer of the UE 602 being zero or (ii) a capability of the UE 602 to delay transmission of a data packet, and/or for the UE 602 to operate in the second mode based on the amount of data in the buffer of the UE 602 being non-zero. In such aspects, the UE 602 may be configured to provide/transmit the status indication 610 (e.g., 710 in FIG. 7; 1006 in FIG. 10), for the base station 604, that indicates the status of the buffer based on the estimated time (e.g., 906, 908 in FIG. 9). The estimated time (e.g., 906, 908 in FIG. 9) may indicate that the time at which the UE 602 estimates the arrival of the next UL packet is shorter than a sleep time to be utilized for the UE 602 to enter a sleep mode. Further, the power state switching indication 614 provided/transmitted for the base station 604 may indicate the mode of operation for the UE 602 as the second mode, in aspects. Additionally, the UE 602 may transmit, to the base station 604, UCI that includes a codepoint for the UE 602. The codepoint for the UE 602 may indicate a first indication to delay operating in a second mode, the second mode consuming less power than a first mode, a second indication that operation in the second mode is acceptable, a third indication to operate in the second mode based on a first time period elapsing, a fourth indication to return to the first mode or transition to a third mode based on a second time period, and/or the like. In aspects, the UCI may be based on and/or in response to the received DL EOC indication 608 from the base station 604.

At 1420, the base station receives, from the UE, an operation indication that indicates an autonomous switch in operation of the UE for the third mode or the second mode, where the operation indication is comprised in at least one of UCI, a MAC-CE, or UAI. As an example, the switching may be performed, at least in part, by the component 199. FIGS. 6-10 illustrate an example of the base station 604 receiving such an operation indication from a UE (e.g., the UE 602).

The UE 602 may be configured to switch (at 612) to a mode of operation for the UE 602 based on a power state switching indication 614 (e.g., 712 in FIG. 7; 810, 814 in FIG. 8) and/or autonomously (e.g., 1060 in FIG. 10) by the UE 602 subsequent to transmitting the status indication 610 (e.g., 710 in FIG. 7; 1006 in FIG. 10). In aspects, the UE 602 may switch (at 612) power states based on the power state switching indication 614 (e.g., 712 in FIG. 7; 810, 814 in FIG. 8), or the UE 602 may autonomously switch (at 612) (e.g., 1060 in FIG. 10) power states subsequent to transmitting the status indication 610 (e.g., 710 in FIG. 7; 1006 in FIG. 10), into (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), or (v) a fifth mode in which the UE is configured to operate in the DL mode and not in the UL mode.

In aspects for which the switch (at 612) is autonomously performed (e.g., 1060 in FIG. 10) by the UE 602, the UE 602 may be configured to switch (at 612), autonomously (e.g., 1060 in FIG. 10), to the various modes of operation. The modes of operation may be (i) a first mode in which the UE 602 is configured to operate in an UL mode and a DL mode, (ii) a second mode in which the UE 602 is configured to operate in the UL mode and not in the DL mode, (iii) a third mode in which the UE 602 is configured to operate with a modem off, (iv) a fourth mode in which the UE 602 is configured to skip monitoring for a PDCCH (e.g., PDCCH skipping), (v) a fifth mode in which the UE 602 is configured to operate in the DL mode and not in the UL mode, and/or the like.

In aspects, the UE 602 may be configured to transmit, for the base station 604, an operation indication (e.g., 818 in FIG. 8; 1012 in FIG. 10) that indicates operation of the UE 602 for the third mode or the second mode. The operation indication (e.g., 818 in FIG. 8; 1012 in FIG. 10) may be comprised in at least one of UCI, a MAC-CE, or UAI, in aspects. In the context of FIG. 10, the UE 1002 (e.g., 602 in FIG. 6) may be configured to provide/transmit for the base station 1004 (e.g., 1004) an operation indication 1012. The operation indication 1012 may indicate, for the base station 1004, which power state/mode of operation the UE 1002 has autonomously entered (e.g., the first, second, third, fourth, fifth, etc., modes described below). In this manner, the base station 1004 is made aware of the autonomous transition of the UE 1002. While in the desired power state/mode of operation for which the UE 1002 has autonomously entered.

At 1422, the base station transmit, to the UE, a WUS that includes a sequence type, where the sequence type is associated with a switch of the UE to another of the first mode, the second mode, the third mode, or the fourth mode for the UE. As an example, the transmission may be performed, at least in part, by the component 199. FIGS. 6-10 illustrate an example of the base station 604 transmitting such a WUS for a UE (e.g., the UE 602).

The UE 602 may be configured to monitor (e.g., at 1014 in FIG. 10), while in the mode of operation (e.g., to which the UE 602 autonomously switched), for a WUS (e.g., a WUS generally, a LP-WUS, etc.) (e.g., 1016 in FIG. 10), from the base station 604, that includes a sequence type (e.g., 1020 in FIG. 10). The UE 602 may also be configured to receive, from the base station 604, the WUS (e.g., 1016 in FIG. 10) that includes the sequence type (e.g., 1020 in FIG. 10), and to switch (e.g., at 1018 in FIG. 10) to another of the first mode, the second mode, the third mode, or the fourth mode for the UE 602 based on the sequence type (e.g., 1020 in FIG. 10). In aspects, the sequence type (e.g., 1020 in FIG. 10) may be (i) a first sequence type that indicates for the UE 602 to wake up and operate in a fifth mode in which the UE 602 is configured to operate in the DL mode and not in the UL mode, (ii) a second sequence type that indicates for the UE 602 to restart retransmission times for retransmission monitoring, (iii) a third sequence type that indicates for the UE 602 to wake up and operate in the second mode, (iv) a fourth sequence type that includes a payload of bits in the WUS, where the payload of bits corresponds to the first sequence type, the second sequence type, or the third sequence type, (iv) a fifth mode in which the UE 602 is configured to operate in the DL mode and not in the UL mode, and/or the like.

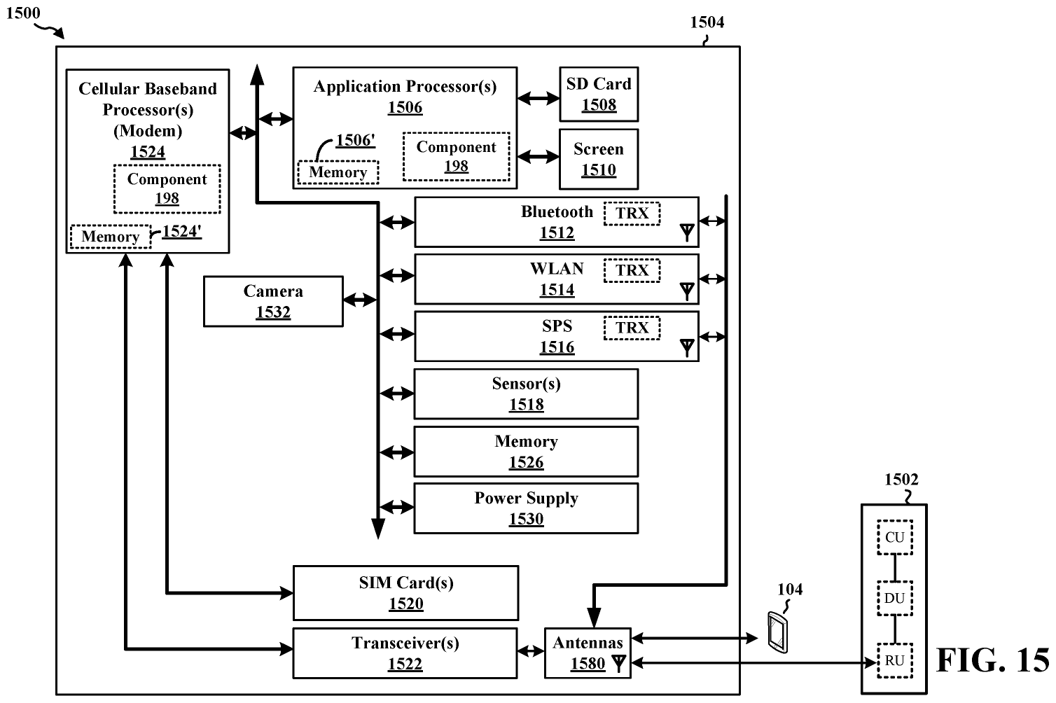

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to receive, from a network node, a downlink DL EOC indication to trigger a status indication. The component 198 may also be configured to transmit, to the network node and based on the DL EOC indication, the status indication indicative of a status of (i) a buffer of the UE or a delay of the UE, and (ii) an estimated time that indicates a time at which the UE estimates an arrival of a next UL packet. The component 198 may be configured to receive, from the network node, a power state switching indication that indicates a mode of operation for the UE based on at least one of the status of the buffer of the UE, the delay of the UE, or the estimated time. The component 198 may be configured to switch to the mode of operation for the UE based on the power state switching indication. The component 198 may be configured to transmit, to the network node, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode based on a second time period. The component 198 may be configured, during a time period after transmitting the status indication and prior to the estimated time, to receive, from the network node, an UL grant for UL traffic associated with data in the buffer of the UE. The component 198 may be configured, during the time period after transmitting the status indication and prior to the estimated time to transmit, for the network node, the UL traffic based on the UL grant. The component 198 may be configured to transmit, for the network node, a capability indication of the UE that indicates at least one of a first capability of the UE to estimate a traffic condition or a second capability of the UE to provide the estimated time. The component 198 may be configured to switch, autonomously by the UE, to a mode of operation for the UE subsequent to transmitting the status indication, where the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a PDCCH. The component 198 may be configured to monitor, while in the mode of operation, for a WUS, from the network node, that includes a sequence type. The component 198 may be configured to receive, from the network node, the WUS that includes the sequence type. The component 198 may be configured to switch to another of the first mode, the second mode, the third mode, or the fourth mode for the UE based on the sequence type. The component 198 may be further configured to perform any of the aspects described in connection with the flowcharts in any of FIGS. 11-14, and/or any of the aspects performed by a sensing node for any of FIGS. 6-10. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node, a downlink DL EOC indication to trigger a status indication. In the configuration, the apparatus 1504, and in particular the cellular baseband processor(s) 1524 and/or the application processor(s) 1506, may include means for transmitting, to the network node and based on the DL EOC indication, the status indication indicative of a status of (i) a buffer of the UE or a delay of the UE, and (ii) an estimated time that indicates a time at which the UE estimates an arrival of a next UL packet. In one configuration, the apparatus 1504, and in particular the cellular baseband processor(s) 1524 and/or the application processor(s) 1506, may include means for receiving, from the network node, a power state switching indication that indicates a mode of operation for the UE based on at least one of the status of the buffer of the UE, the delay of the UE, or the estimated time. In one configuration, the apparatus 1504, and in particular the cellular baseband processor(s) 1524 and/or the application processor(s) 1506, may include means for switching to the mode of operation for the UE based on the power state switching indication. In one configuration, the apparatus 1504, and in particular the cellular baseband processor(s) 1524 and/or the application processor(s) 1506, may include means for transmitting, to the network node, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode based on a second time period. In one configuration, the apparatus 1504, and in particular the cellular baseband processor(s) 1524 and/or the application processor(s) 1506, may include means for, during a time period after transmitting the status indication and prior to the estimated time, receiving, from the network node, an UL grant for UL traffic associated with data in the buffer of the UE. In one configuration, the apparatus 1504, and in particular the cellular baseband processor(s) 1524 and/or the application processor(s) 1506, may include means for, during the time period after transmitting the status indication and prior to the estimated time, transmitting, for the network node, the UL traffic based on the UL grant. In one configuration, the apparatus 1504, and in particular the cellular baseband processor(s) 1524 and/or the application processor(s) 1506, may include means for transmitting, for the network node, a capability indication of the UE that indicates at least one of a first capability of the UE to estimate a traffic condition or a second capability of the UE to provide the estimated time. In one configuration, the apparatus 1504, and in particular the cellular baseband processor(s) 1524 and/or the application processor(s) 1506, may include means for switching, autonomously by the UE, to a mode of operation for the UE subsequent to transmitting the status indication, where the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a PDCCH. In one configuration, the apparatus 1504, and in particular the cellular baseband processor(s) 1524 and/or the application processor(s) 1506, may include means for monitoring, while in the mode of operation, for a WUS, from the network node, that includes a sequence type. In one configuration, the apparatus 1504, and in particular the cellular baseband processor(s) 1524 and/or the application processor(s) 1506, may include means for receiving, from the network node, the WUS that includes the sequence type. In one configuration, the apparatus 1504, and in particular the cellular baseband processor(s) 1524 and/or the application processor(s) 1506, may include means for switching to another of the first mode, the second mode, the third mode, or the fourth mode for the UE based on the sequence type. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

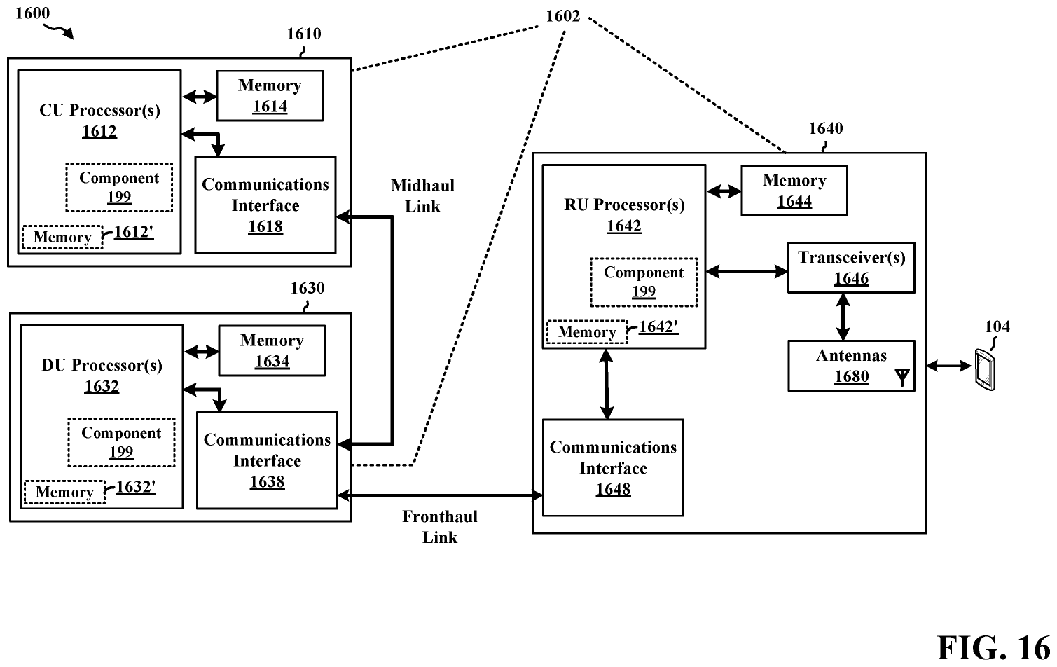

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a UE, a DL EOC indication to trigger a status indication. The component 199 may also be configured to receive, from the UE and based on the DL EOC indication, the status indication indicative of a status of (i) a buffer of the UE or a delay of the UE, and (ii) an estimated time that indicates a time at which the UE estimates an arrival of a next UL packet. The component 199 may be configured to transmit, to the UE, a power state switching indication that indicates a mode of operation for the UE based on at least one of the status of the buffer of the UE, the delay of the UE, or the estimated time. The component 199 may be configured to receive, from the UE, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode wake up based on a second period of time. The component 199 may be configured, during a time period after transmitting the status indication and prior to the estimated time, to transmit, for the UE, an UL grant for UL traffic associated with data in the buffer of the UE. The component 199 may be configured, during the time period after transmitting the status indication and prior to the estimated time, to receive, from the UE, the UL traffic based on the UL grant. The component 199 may be configured to receive, from the UE, a capability indication of the UE that indicates at least one of a first capability of the UE to estimate a traffic condition or a second capability of the UE to provide the estimated time. The component 199 may be configured to receive, from the UE, an operation indication that indicates an autonomous switch in operation of the UE for the third mode or the second mode, where the operation indication is comprised in at least one of UCI, a MAC-CE, or UAI. The component 199 may be configured to transmit, to the UE, a WUS that includes a sequence type, where the sequence type is associated with a switch of the UE to another of the first mode, the second mode, the third mode, or the fourth mode for the UE. The component 199 may be further configured to perform any of the aspects described in connection with the flowcharts in any of FIGS. 11-14, and/or any of the aspects performed by a sensing node for any of FIGS. 6-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, to a UE, a DL EOC indication to trigger a status indication. In the configuration, the network entity 1602 may include means for receiving, from the UE and based on the DL EOC indication, the status indication indicative of a status of (i) a buffer of the UE or a delay of the UE, and (ii) an estimated time that indicates a time at which the UE estimates an arrival of a next UL packet. In one configuration, the network entity 1602 may include means for transmitting, to the UE, a power state switching indication that indicates a mode of operation for the UE based on at least one of the status of the buffer of the UE, the delay of the UE, or the estimated time. In one configuration, the network entity 1602 may include means for receiving, from the UE, UCI that includes a codepoint for the UE, where the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode wake up based on a second period of time. In one configuration, the network entity 1602 may include means for, during a time period after transmitting the status indication and prior to the estimated time, transmitting, for the UE, an UL grant for UL traffic associated with data in the buffer of the UE. In one configuration, the network entity 1602 may include means for, during the time period after transmitting the status indication and prior to the estimated time, receiving, from the UE, the UL traffic based on the UL grant. In one configuration, the network entity 1602 may include means for receiving, from the UE, a capability indication of the UE that indicates at least one of a first capability of the UE to estimate a traffic condition or a second capability of the UE to provide the estimated time. In one configuration, the network entity 1602 may include means for receiving, from the UE, an operation indication that indicates an autonomous switch in operation of the UE for the third mode or the second mode, where the operation indication is comprised in at least one of UCI, a MAC-CE, or UAI. In one configuration, the network entity 1602 may include means for transmitting, to the UE, a WUS that includes a sequence type, where the sequence type is associated with a switch of the UE to another of the first mode, the second mode, the third mode, or the fourth mode for the UE. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Traffic flows in wireless communication networks may have various characteristics in wireless communication networks, e.g., including layer attributes, timeframes for latency, power saving configurations, etc. As an example, XR traffic for UL and DL may have characteristics such as application layer attributes, short timeframes for exchange where longer latency for traffic flows may reduce a user experience with an XR application or device, unbalanced traffic flows, etc. Power saving configurations for XR may include UL states (e.g., without DL communications) triggered by inactivity or express triggers (e.g., via DCI). Other configurations, such as for PDCCH skipping, may save power by allowing a UE skip monitoring for DL PDCCH data/information. However, existing power saving configurations for 5G NR may not be suitable for advanced networks, such as 6G networks. For instance, in the context of XR, 5G implementations may have insufficient granularity with DRX or C-DRX active-inactive states, and C-DRX transitions designed for eMBB/voice traffic may have inactivity timers that fail to ensure fast transitions. SSSG state/PDCCH skipping may provide more flexibility but do not take quasi-periodic structures into account and do not provide sufficient granularity of power states (e.g. UL power states without DL monitoring). Further regarding PDCCH skipping, latency may be introduced for UL scheduling as communication (in both UL and DL) may not occur when a UE does not monitor PDCCH. To reduce the UL scheduling latency, a UE may indicate the stop of PDCCH skipping or to override the SSSG switching via the transmission of a SR if the UE has urgent UL data to transmit (e.g., the UE may switch back to regular PDCCH monitoring to monitor uplink grants after sending the SR. Yet, such configurations do not account for scenarios without urgent UL data. For instance, while 5G NR may allow a UE to cancel PDCCH skipping, a base station (e.g., a gNB and/or the like) may have already sent a superfluous PDCCH skipping indication for the UE to go sleep (whether this is scheduling DCI or non-scheduling DCI-a non-scheduling DCI may be in the form of dummy grant with zero resource block allocation and used for indicating PDCCH skipping (e.g., used for nothing else)). Further, a base station (e.g., a gNB and/or the like) may not have awareness/information that a UE is going to send a positive SR so close to a PDCCH skipping indication, which may also warrant the base station to send a superfluous indication. Accordingly, prior solutions lack optimizations by which a base station (e.g., a gNB and/or the like) may be aware/have information that there is UL data coming soon enough that the base station may make better decisions on whether to send skipping indications or not. Aspects herein provide solutions that cover transitions in an out of power states.

Various aspects herein for on power state transitions improve efficiency of communications and reduce consumption power of devices associated with a wireless network by enhancing status reports to include estimated times for UL data and/or delay reports. Aspects also further improve efficiency of communications and reduce power consumption of wireless devices, as well as quickly provide UE information to a base station without additional signaling, by utilizing DL EOC indications to trigger status reports. Aspects also allow a UE to autonomously transition to a different power state after providing a status indication to a base station by monitoring of various wake up signals.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, a downlink (DL) end of communication (EOC) indication to trigger a status indication; and transmitting, to the network node and based on the DL EOC indication, the status indication indicative of a status of (i) a buffer of the UE or a delay of the UE, and (ii) an estimated time that indicates a time at which the UE estimates an arrival of a next UL packet.

Aspect 2 is the method of aspect 1, further comprising: receiving, from the network node, a power state switching indication that indicates a mode of operation for the UE based on at least one of the status of the buffer of the UE, the delay of the UE, or the estimated time.

Aspect 3 is the method of aspect 2, wherein the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; a fourth mode in which the UE is configured to skip monitoring for a physical downlink control channel (PDCCH); or a fifth mode in which the UE is configured to operate in the DL mode and not in the UL mode.

Aspect 4 is the method of aspect 3, wherein the power state switching indication is based on the DL EOC indication and is comprised in downlink control information (DCI), wherein the power state switching indication indicates at least one of: to operate in the third mode based on (i) an amount of data in the buffer of the UE being zero or (ii) a capability of the UE to delay transmission of a data packet; or to operate in the second mode based on the amount of data in the buffer of the UE being non-zero.

Aspect 5 is the method of aspect 3, wherein transmitting the status indication that indicates the status of the buffer is based on the estimated time, wherein the estimated time indicates that the time at which the UE estimates the arrival of the next UL packet is shorter than a sleep time to be utilized for the UE to enter a sleep mode, and wherein the power state switching indication indicates the mode of operation for the UE as the second mode.

Aspect 6 is the method of aspect 2, further comprising: switching to the mode of operation for the UE based on the power state switching indication.

Aspect 7 is the method of any of aspects 1 to 6, further comprising: transmitting, to the network node, uplink control information (UCI) that includes a codepoint for the UE, wherein the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode based on a second time period.

Aspect 8 is the method of aspect 7, wherein transmitting the UCI is based on the received DL EOC indication from the network node.

Aspect 9 is the method of any of aspects 1 to 8, wherein the status indication comprises at least one of: a buffer status report (BSR) that is comprised in a medium access control (MAC) control element (MAC-CE); or a delay status report (DSR) that indicates a status of the delay of the UE; and wherein the EOC is at least one of an end of burst (EOB) indication, a physical downlink control channel (PDCCH) skipping indication, a discontinuous reception (DRX) MAC-CE, a DL end of retransmissions indication, a DL feedback indication (DFI) that indicates an acknowledgement (ACK) for UL packets, or a Layer 1 (L1) or Layer 2 (L2) signaling of an end of cell DRX or an end of DRX active time.

Aspect 10 is the method of any of aspects 1 to 9, further comprising: during a time period after transmitting the status indication and prior to the estimated time: receiving, from the network node, an UL grant for UL traffic associated with data in the buffer of the UE; and transmitting, for the network node, the UL traffic based on the UL grant.

Aspect 11 is the method of any of aspects 1 to 10, further comprising: transmitting, for the network node, a capability indication of the UE that indicates at least one of a first capability of the UE to estimate a traffic condition or a second capability of the UE to provide the estimated time.

Aspect 12 is the method of any of aspects 1 and 7 to 11, further comprising: switching, autonomously by the UE, to a mode of operation for the UE subsequent to transmitting the status indication, wherein the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a physical downlink control channel (PDCCH).

Aspect 13 is the method of aspect 12, further comprising: transmitting, for the network node, an operation indication that indicates operation of the UE for the third mode or the second mode, wherein the operation indication is comprised in at least one of uplink control information (UCI), a medium access control (MAC) control element (MAC-CE), or UE assistance information (UAI).

Aspect 14 is the method of aspect 13, further comprising: monitoring, while in the mode of operation, for a wake up signal (WUS), from the network node, that includes a sequence type; receiving, from the network node, the WUS that includes the sequence type; and switching to another of the first mode, the second mode, the third mode, or the fourth mode for the UE based on the sequence type.

Aspect 15 is the method of aspect 14, wherein the sequence type is at least one of: a first sequence type that indicates for the UE to wake up and operate in a fifth mode in which the UE is configured to operate in the DL mode and not in the UL mode; a second sequence type that indicates for the UE to restart retransmission times for retransmission monitoring; a third sequence type that indicates for the UE to wake up and operate in the second mode; or a fourth sequence type that includes a payload of bits in the WUS, wherein the payload of bits corresponds to the first sequence type, the second sequence type, or the third sequence type.

Aspect 16 is a method of wireless communication at a network node, comprising: transmitting, to a user equipment (UE), a downlink (DL) end of communication (EOC) indication to trigger a status indication; and receiving, from the UE and based on the DL EOC indication, the status indication indicative of a status of (i) a buffer of the UE or a delay of the UE, and (ii) an estimated time that indicates a time at which the UE estimates an arrival of a next UL packet.

Aspect 17 is the method of aspect 16, further comprising: transmitting, to the UE, a power state switching indication that indicates a mode of operation for the UE based on at least one of the status of the buffer of the UE, the delay of the UE, or the estimated time.

Aspect 18 is the method of aspect 17, wherein the mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a physical downlink control channel (PDCCH).

Aspect 19 is the method of aspect 18, wherein the power state switching indication is based on the UL EOC indication and is comprised in downlink control information (DCI), wherein the power state switching indication indicates at least one of: to operate in the third mode based on (i) an amount of data in the buffer of the UE being zero or (ii) a capability of the UE to delay transmission of a data packet; or to operate in the second mode based on the amount of data in the buffer of the UE being non-zero.

Aspect 20 is the method of aspect 18, wherein receiving the status indication that indicates the status of the buffer is based on the estimated time, wherein the estimated time indicates that the time at which the UE estimates the arrival of the next UL packet is shorter than a sleep time to be utilized for the UE to enter a sleep mode, and wherein the power state switching indication indicates the mode of operation for the UE as the second mode.

Aspect 21 is the method of any of aspects 16 to 20, further comprising: receiving, from the UE, uplink control information (UCI) that includes a codepoint for the UE, wherein the codepoint for the UE indicates at least one of: a first indication to delay operating in a second mode, the second mode consuming less power than a first mode; a second indication that operation in the second mode is acceptable; a third indication to operate in the second mode based on a first time period elapsing; or a fourth indication to return to the first mode or transition to a third mode wake up based on a second period of time.

Aspect 22 is the method of aspect 21, wherein the UCI is in response to the DL EOC indication from the network node.

Aspect 23 is the method of any of aspects 16 to 22, wherein the status indication comprises at least one of: a buffer status report (BSR) that is comprised in a medium access control (MAC) control element (MAC-CE); or a delay status report (DSR) that indicates a status of the delay of the UE; and wherein the EOC is at least one of an end of burst (EOB) indication, a physical downlink control channel (PDCCH) skipping indication, a discontinuous reception (DRX) MAC-CE, a DL end of retransmissions indication, a DL feedback indication (DFI) that indicates an acknowledgement (ACK) for UL packets, or a Layer 1 (L1) or Layer 2 (L2) signaling of an end of cell DRX or an end of DRX active time.

Aspect 24 is the method of any of aspects 16 to 23, further comprising: during a time period after transmitting the status indication and prior to the estimated time: transmitting, for the UE, an UL grant for UL traffic associated with data in the buffer of the UE; and receiving, from the UE, the UL traffic based on the UL grant.

Aspect 25 is the method of any of aspects 16 to 24, further comprising: receiving, from the UE, a capability indication of the UE that indicates at least one of a first capability of the UE to estimate a traffic condition or a second capability of the UE to provide the estimated time.

Aspect 26 is the method of any of aspects 16 and 21 to 24, wherein a mode of operation for the UE is: a first mode in which the UE is configured to operate in an UL mode and a DL mode; a second mode in which the UE is configured to operate in the UL mode and not in the DL mode; a third mode in which the UE is configured to operate with a modem off; or a fourth mode in which the UE is configured to skip monitoring for a physical downlink control channel (PDCCH); the method further comprising: receiving, from the UE, an operation indication that indicates an autonomous switch in operation of the UE for the third mode or the second mode, wherein the operation indication is comprised in at least one of uplink control information (UCI), a medium access control (MAC) control element (MAC-CE), or UE assistance information (UAI), and transmitting, to the UE, a wake up signal (WUS) that includes a sequence type, wherein the sequence type is associated with a switch of the UE to another of the first mode, the second mode, the third mode, or the fourth mode for the UE.

Aspect 27 is the method of aspect 26, wherein the sequence type is at least one of: a first sequence type that indicates for the UE to wake up and operate in a fifth mode in which the UE is configured to operate in the DL mode and not in the UL mode; a second sequence type that indicates for the UE to restart retransmission times for retransmission monitoring; a third sequence type that indicates for the UE to wake up and operate in the second mode; or a fourth sequence type that includes a payload of bits in the WUS, wherein the payload of bits corresponds to the first sequence type, the second sequence type, or the third sequence type.

Aspect 28 is an apparatus for wireless communication including means for implementing any of aspects 1 to 15.

Aspect 29 is a computer-readable medium (e.g., a non-transitory computer-readable medium) storing computer executable code, the code when executed by at least one processor causes the at least one processor to implement any of aspects 1 to 15.

Aspect 30 is an apparatus for wireless communication at a network node. The apparatus includes a memory; and at least one processor coupled to the memory and, based at least in part on information stored in the memory, the at least one processor is configured to implement any of aspects 1 to 15.

Aspect 31 is the apparatus of aspect 30, further including at least one of a transceiver or an antenna coupled to the at least one processor.

Aspect 32 is an apparatus for wireless communication including means for implementing any of aspects 16 to 27.

Aspect 33 is a computer-readable medium (e.g., a non-transitory computer-readable medium) storing computer executable code, the code when executed by at least one processor causes the at least one processor to implement any of aspects 16 to 27.

Aspect 34 is an apparatus for wireless communication at a network node. The apparatus includes a memory; and at least one processor coupled to the memory and, based at least in part on information stored in the memory, the at least one processor is configured to implement any of aspects 16 to 27.

Aspect 35 is the apparatus of aspect 35, further including at least one of a transceiver or an antenna coupled to the at least one processor.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a downlink (DL) end of communication (EOC) indication to trigger a status indication; and
transmit, to the network node and based on the DL EOC indication, the status indication indicative of a status of (i) a buffer of the UE or a delay of the UE, and (ii) an estimated time that indicates a time at which the UE estimates an arrival of a next UL packet.

2. The apparatus of claim 1, wherein the at least one processor, individually or in any combination, is further configured to:
receive, from the network node, a power state switching indication that indicates a mode of operation for the UE based on at least one of the status of the buffer of the UE, the delay of the UE, or the estimated time.

3. The apparatus of claim 2, wherein the mode of operation for the UE is:
a first mode in which the UE is configured to operate in an UL mode and a DL mode;
a second mode in which the UE is configured to operate in the UL mode and not in the DL mode;
a third mode in which the UE is configured to operate with a modem off;
a fourth mode in which the UE is configured to skip monitoring for a physical downlink control channel (PDCCH); or
a fifth mode in which the UE is configured to operate in the DL mode and not in the UL mode.

4. The apparatus of claim 3, wherein the power state switching indication is based on the DL EOC indication and is comprised in downlink control information (DCI), wherein the power state switching indication indicates at least one of:
to operate in the third mode based on (i) an amount of data in the buffer of the UE being zero or (ii) a capability of the UE to delay transmission of a data packet; or
to operate in the second mode based on the amount of data in the buffer of the UE being non-zero.

5. The apparatus of claim 3, wherein to transmit the status indication that indicates the status of the buffer is based on the estimated time, wherein the estimated time indicates that the time at which the UE estimates the arrival of the next UL packet is shorter than a sleep time to be utilized for the UE to enter a sleep mode, and wherein the power state switching indication indicates the mode of operation for the UE as the second mode.

6. The apparatus of claim 2, further wherein the at least one processor, individually or in any combination, is further configured to:
switch to the mode of operation for the UE based on the power state switching indication.

7. The apparatus of claim 1, wherein the at least one processor, individually or in any combination, is further configured to:
transmit, to the network node, uplink control information (UCI) that includes a codepoint for the UE, wherein the codepoint for the UE indicates at least one of:
a first indication to delay operating in a second mode, the second mode consuming less power than a first mode;
a second indication that operation in the second mode is acceptable;
a third indication to operate in the second mode based on a first time period elapsing; or
a fourth indication to return to the first mode or transition to a third mode based on a second time period.

8. The apparatus of claim 7, wherein to transmit the UCI is based on the received DL EOC indication from the network node.

9. The apparatus of claim 1, wherein the status indication comprises at least one of:
a buffer status report (BSR) that is comprised in a medium access control (MAC) control element (MAC-CE); or
a delay status report (DSR) that indicates a status of the delay of the UE; and
wherein the EOC is at least one of an end of burst (EOB) indication, a physical downlink control channel (PDCCH) skipping indication, a discontinuous reception (DRX) MAC-CE, a DL end of retransmissions indication, a DL feedback indication (DFI) that indicates an acknowledgement (ACK) for UL packets, or a Layer 1 (L1) or Layer 2 (L2) signaling of an end of cell DRX or an end of DRX active time.

10. The apparatus of claim 1, further comprising:
during a time period after transmitting the status indication and prior to the estimated time:
receive, from the network node, an UL grant for UL traffic associated with data in the buffer of the UE; and
transmit, for the network node, the UL traffic based on the UL grant.

11. The apparatus of claim 1, wherein the at least one processor, individually or in any combination, is further configured to:
transmit, for the network node, a capability indication of the UE that indicates at least one of a first capability of the UE to estimate a traffic condition or a second capability of the UE to provide the estimated time.

12. The apparatus of claim 1, wherein the at least one processor, individually or in any combination, is further configured to:
switch, autonomously by the UE, to a mode of operation for the UE subsequent to transmitting the status indication, wherein the mode of operation for the UE is:
a first mode in which the UE is configured to operate in an UL mode and a DL mode;
a second mode in which the UE is configured to operate in the UL mode and not in the DL mode;
a third mode in which the UE is configured to operate with a modem off;
a fourth mode in which the UE is configured to skip monitoring for a physical downlink control channel (PDCCH); or
a fifth mode in which the UE is configured to operate in the DL mode and not in the UL mode.

13. The apparatus of claim 12, wherein the at least one processor, individually or in any combination, is further configured to:
transmit, for the network node, an operation indication that indicates operation of the UE for the third mode or the second mode, wherein the operation indication is comprised in at least one of uplink control information (UCI), a medium access control (MAC) control element (MAC-CE), or UE assistance information (UAI).

14. The apparatus of claim 13, wherein the at least one processor, individually or in any combination, is further configured to:
monitor, while in the mode of operation, for a wake up signal (WUS), from the network node, that includes a sequence type;
receive, from the network node, the WUS that includes the sequence type; and
switch to another of the first mode, the second mode, the third mode, or the fourth mode for the UE based on the sequence type.

15. The apparatus of claim 14, wherein the sequence type is at least one of:
a first sequence type that indicates for the UE to wake up and operate in the fifth mode in which the UE is configured to operate in the DL mode and not in the UL mode;
a second sequence type that indicates for the UE to restart retransmission times for retransmission monitoring;
a third sequence type that indicates for the UE to wake up and operate in the second mode; or
a fourth sequence type that includes a payload of bits in the WUS, wherein the payload of bits corresponds to the first sequence type, the second sequence type, or the third sequence type.

16. An apparatus for wireless communication at a network node, comprising:
at least one memory; and
at least one processor coupled to the at least one memory and, based at least in part on information stored in the at least one memory, the at least one processor, individually or in any combination, is configured to:
transmit, to a user equipment (UE), a downlink (DL) end of communication (EOC) indication to trigger a status indication; and
receive, from the UE and based on the DL EOC indication, the status indication indicative of a status of (i) a buffer of the UE or a delay of the UE, (ii) and an estimated time that indicates a time at which the UE estimates an arrival of a next UL packet.

17. The apparatus of claim 16, wherein the at least one processor, individually or in any combination, is further configured to:
transmit, to the UE, a power state switching indication that indicates a mode of operation for the UE based on at least one of the status of the buffer of the UE, the delay of the UE, or the estimated time.

18. The apparatus of claim 17, wherein the mode of operation for the UE is:
a first mode in which the UE is configured to operate in an UL mode and a DL mode;
a second mode in which the UE is configured to operate in the UL mode and not in the DL mode;
a third mode in which the UE is configured to operate with a modem off; or
a fourth mode in which the UE is configured to skip monitoring for a physical downlink control channel (PDCCH).

19. The apparatus of claim 18, wherein the power state switching indication is based on the UL EOC indication and is comprised in downlink control information (DCI), wherein the power state switching indication indicates at least one of:
to operate in the third mode based on (i) an amount of data in the buffer of the UE being zero or (ii) a capability of the UE to delay transmission of a data packet; or
to operate in the second mode based on the amount of data in the buffer of the UE being non-zero.

20. The apparatus of claim 18, wherein to receive the status indication that indicates the status of the buffer is based on the estimated time, wherein the estimated time indicates that the time at which the UE estimates the arrival of the next UL packet is shorter than a sleep time to be utilized for the UE to enter a sleep mode, and wherein the power state switching indication indicates the mode of operation for the UE as the second mode.

21. The apparatus of claim 16, wherein the at least one processor, individually or in any combination, is further configured to:
receive, from the UE, uplink control information (UCI) that includes a codepoint for the UE, wherein the codepoint for the UE indicates at least one of:
a first indication to delay operating in a second mode, the second mode consuming less power than a first mode;
a second indication that operation in the second mode is acceptable;
a third indication to operate in the second mode based on a first time period elapsing; or
a fourth indication to return to the first mode or transition to a third mode wake up based on a second period of time.

22. The apparatus of claim 21, wherein the UCI is in response to the DL EOC indication from the network node.

23. The apparatus of claim 16, wherein the status indication comprises at least one of:
a buffer status report (BSR) that is comprised in a medium access control (MAC) control element (MAC-CE); or
a delay status report (DSR) that indicates a status of the delay of the UE; and
wherein the EOC is at least one of an end of burst (EOB) indication, a physical downlink control channel (PDCCH) skipping indication, a discontinuous reception (DRX) MAC-CE, a DL end of retransmissions indication, a DL feedback indication (DFI) that indicates an acknowledgement (ACK) for UL packets, or a Layer 1 (L1) or Layer 2 (L2) signaling of an end of cell DRX or an end of DRX active time.

24. The apparatus of claim 16, wherein the at least one processor, individually or in any combination, is further configured to:
during a time period after receiving the status indication and prior to the estimated time:
transmit, for the UE, an UL grant for UL traffic associated with data in the buffer of the UE; and
receive, from the UE, the UL traffic based on the UL grant.

25. The apparatus of claim 16, wherein the at least one processor, individually or in any combination, is further configured to:
receive, from the UE, a capability indication of the UE that indicates at least one of a first capability of the UE to estimate a traffic condition or a second capability of the UE to provide the estimated time.

26. The apparatus of claim 16, wherein a mode of operation for the UE is:
a first mode in which the UE is configured to operate in an UL mode and a DL mode;
a second mode in which the UE is configured to operate in the UL mode and not in the DL mode;
a third mode in which the UE is configured to operate with a modem off;
a fourth mode in which the UE is configured to skip monitoring for a physical downlink control channel (PDCCH); or
a fifth mode in which the UE is configured to operate in the DL mode and not in the UL mode;
wherein the at least one processor, individually or in any combination, is further configured to:
receive, from the UE, an operation indication that indicates an autonomous switch in operation of the UE for the third mode or the second mode, wherein the operation indication is comprised in at least one of uplink control information (UCI), a medium access control (MAC) control element (MAC-CE), or UE assistance information (UAI), and
transmit, to the UE, a wake up signal (WUS) that includes a sequence type, wherein the sequence type is associated with a switch of the UE to another of the first mode, the second mode, the third mode, or the fourth mode for the UE.

27. The apparatus of claim 26, wherein the sequence type is at least one of:
a first sequence type that indicates for the UE to wake up and operate in the fifth mode in which the UE is configured to operate in the DL mode and not in the UL mode;
a second sequence type that indicates for the UE to restart retransmission times for retransmission monitoring;
a third sequence type that indicates for the UE to wake up and operate in the second mode; or
a fourth sequence type that includes a payload of bits in the WUS, wherein the payload of bits corresponds to the first sequence type, the second sequence type, or the third sequence type.

28. A method of wireless communication at a user equipment (UE), comprising:
receiving, from a network node, a downlink (DL) end of communication (EOC) indication to trigger a status indication; and
transmitting, to the network node and based on the DL EOC indication, the status indication indicative of a status of (i) a buffer of the UE or a delay of the UE, and (ii) an estimated time that indicates a time at which the UE estimates an arrival of a next UL packet.

29. The method of claim 28, further comprising:
receiving, from the network node, a power state switching indication that indicates a mode of operation for the UE based on at least one of the status of the buffer of the UE, the delay of the UE, or the estimated time.

30. A method of wireless communication at a network node, comprising:
transmitting, to a user equipment (UE), a downlink (DL) end of communication (EOC) indication to trigger a status indication; and
receiving, from the UE and based on the DL EOC indication, the status indication indicative of a status of (i) a buffer of the UE or a delay of the UE, and (ii) an estimated time that indicates a time at which the UE estimates an arrival of a next UL packet.
